(19) United States
(12) Patent Application Publication
(10) Pub. No.: US 2024/0343978 A1
(43) Pub. Date: Oct. 17, 2024

(54) METHOD AND APPARATUS FOR CONVERTING CARBON-BASED FEEDSTOCKS INTO USABLE PRODUCTS USING ROTARY GENERATED THERMAL ENERGY

(71) Applicant: Coolbrook Oy, Helsinki (FI)

(72) Inventors: Tuomas OUNI, Helsinki (FI); Veli Matti PUROLA, Helsinki (FI)

(21) Appl. No.: 18/618,595

(22) Filed: Mar. 27, 2024

Related U.S. Application Data
(60) Provisional application No. 63/495,641, filed on Apr. 12, 2023.

(51) Int. Cl. C10B 49/10; B01J 6/00; C10B 53/00; C10B 53/07; C10B 57/06; C22B 5/10

(52) U.S. Cl. CPC C10B 49/10; B01J 6/008; C10B 53/00; C10B 53/07; C10B 57/06; C22B 5/10

(57) ABSTRACT

A method for thermal or thermochemical conversion of carbon-based feedstocks into usable products in a feedstock conversion facility is provided. The method comprises generating heated fluidic medium by at least one rotary apparatus, supplying a stream of thus generated heated fluidic medium into the feedstock conversion facility, and operating said at least one rotary apparatus and said feedstock conversion facility to carry out thermal or thermochemical conversion of the carbon-based feedstocks into usable products at temperatures essentially equal to or exceeding about 400 degrees Celsius (° C.). The method is beneficial in processing of plastic and/or organic feedstocks.

### FIELD OF THE INVENTION

The present invention generally relates to systems and methods for inputting thermal energy (heat) into fluids. In particular, the invention aims at providing tools and processes for converting carbon-based feedstocks into usable products via thermal or thermochemical reactions carried out at high and extremely high temperatures.

### BACKGROUND

A number of high-temperature methods are available for the conversion of carbon-based (carbonaceous) feedstocks into valuable products. These methods generally run at temperatures of about 500° C. and beyond and include gasification, pyrolysis, combustion, incineration, torrefaction, and the like. Although different in terms of temperature and pressure regime, presence or absence of oxygen, presence or absence of catalyst, and other process conditions, these methods have been employed in disposal and/or recycling of carbonaceous substances including essentially solid waste materials.

Significant amount of waste produced globally nowadays is represented with plastic materials. Today, a chain for common plastics manufacturing starts from fossil raw materials, such as crude oil or natural gas, from which a feedstock for plastics is refined. Common feedstocks include naphtha from oil refining or ethane from natural gas plants. Traditionally, such feedstock is converted into polymer building blocks (monomers), such as ethylene or propylene, in a steam cracker and polymerized into corresponding polymers, such as polyethylene and polypropylene, in polymerization plants. These polymers are then typically blended with additives that provide desired additional properties for the polymers. The final, pellet-shaped polymer-additive blend is called plastics and is used to manufacture a variety of consumer products. After the use of these products, they are typically disposed to waste. Vast majority of plastic waste ends today in landfills, from where the waste is prone to be washed into nature and marine ecosystem particularly if the landfills are unmanaged. In developed countries the tendency during last decade has been to ban landfill disposal of plastics, leading to incineration of plastic waste. However, incineration of waste, a so-called “energetic recycling”, is the largest contributor of carbon dioxide emissions in the plastics value chain.

On the other hand, an increasing amount generally biodegradable organic substances, such as biomass wastes originating from agriculture and forestry, farming, various industries, as well as municipal solid waste (MSW), have attracted much attention around the world in view of rational reuse of these substances.

Converting carbon-based substances into value-added products and energy is an undoubtedly more attractive option compared to landfilling in both environmental and monetary aspects.

High-temperature feedstock conversion methods utilizing gas-solid heat and mass transfer principles along with a fluidization phenomenon include at least gasification and pyrolysis. Gasification converts essentially solid carbonaceous feedstocks into synthesis gas, which can further be used as raw material for synthesis of industrially relevant base chemicals and raw materials, such as methanol, ethanol or Fischer-Tropsch hydrocarbons. On the other hand, pyrolysis yields, along with the gaseous products, also liquid and solids. When used with fluidized bed equipment, the most notable differences between these conversion processes are as follows: 1) pyrolysis takes place in oxygen-free environment (i.e. in an absence of steam, air or oxygen), while gasification occurs with controlled amount of oxygen; and 2) pyrolysis generally proceeds at lower temperatures than gasification. Still, both processes are endothermic in nature and hence require thermal energy to proceed.

FIGS. 5A and 5B schematically illustrate conventional gasifier systems for production of synthesis gas employing fluidization technology. Heat required to maintain gasification reactions, that are endothermic in nature, can be generated in the gasification reactor, wherein a process is referred to as direct gasification; or heat can be supplied into the gasifier from the outside, wherein a process is referred to as indirect gasification.

In direct gasification (FIG. 5A), a gasification agent (GA), such as air or mixtures of oxygen (or oxygen-enriched air) and steam, is contacted with the carbonaceous feed material (see arrow F, for Feed) directly in a gasification reactor (GR) causing a series of chemical reactions to occur that convert essentially solid feedstock (F) to product gas (P), hereby, syngas, and Solid Residue (SR), such as char, ash, slag, etc. One of the disadvantages of using air as a gasification agent is that it results in a product syngas with relatively high levels of nitrogen, which decreases heat value of the product gas. Also, removal of nitrogen in downstream equipment (not shown) is complex and energy-consuming (and therefore expensive). Oxygen/steam-blown method does not produce nitrogen; however, it requires an air separation unit to produce oxygen which again incurs additional costs on the production process.

Indirect gasification (FIG. 5B) involves two separate interconnected reactors, namely, gasification reactor (GR) and combustion reactor (CR), also called regenerator or furnace, and heat is transferred from CR to GR. The transfer of heat is accomplished by means of circulation of inert bed material, and the system is then known as Dual Fluidized Bed gasifier (DFB). In DFB systems, a bed of particulate material, which comprises inert particulate, e.g. sand, is heated with burning external fuel in the CR in presence of air (Oxidizing Agent, OA) while simultaneously fluidizing the bed material using hot gases from the combustion. Heated and fluidized bed material (“Bed material+heat”) is transferred to gasification reactor, in where it is rapidly contacted with essentially solid Feed (arrow F) to yield a gaseous Product (arrow P). Heated bed material transferred from CR to GR thus acts as a heat transfer substance which provides heat for gasification reactions in the GR. In indirect approach, steam (pre) heated to operating temperature ranges (typically 650-900° C.) is used as a gasification agent (GA), which also assists unform mixing of bed material with and feed (fluidization). Cold bed material containing unreacted char (“Bed material+char”) is transferred from gasification reactor back to the combustion reactor for re-heating. Unreacted char remaining in circulating bed material is combusted in the CR. Depending on desired conditions, this can be the only fuel source for the combustor or additional fuel (e.g. a portion of feedstock or of a recycled product gas) can be fed to combustor (see dashed line “Fuel”) to raise the process temperature. Solid residue (SR) is withdrawn for disposal.

Gasification systems described herein above may be further adapted to carry out pyrolysis reactions.

Although related conversion technologies have been developed for decades, one of the major drawbacks associated with known high-temperature conversion methods, such as gasification, incineration, etc. remains an extremely high amount of greenhouse gas (GHG) emissions, primarily carbon dioxide (CO₂), associated with the conversion processes. High CO₂ emissions arise because at least a part of feedstock is consumed, often together with supplementary fossil fuels, for energetic purposes (incinerated or combusted) to provide high temperatures needed in conversion of the rest of feedstock bulk into desired products.

In this regard, an update in the field of technology related to design and manufacturing of a cost- and energy efficient heating system, in particular those suitable for high-temperature waste conversion and recycling, is still desired, in view of addressing challenges associated with raising temperatures of fluidic substances in rational and environmentally friendly manner.

### SUMMARY OF THE INVENTION

An objective of the present invention is to solve or to at least mitigate at least some of the problems arising from the limitations and disadvantages of the related art. One or more objectives are achieved by various embodiments of the methods for generation of a heated fluidic medium described herein, the rotary apparatuses and related uses as defined herein.

In an aspect, a method for thermal or thermochemical conversion of carbon-based feedstocks into usable products is provided, the method comprises generation of a heated fluidic medium by at least one rotary apparatus integrated into a related feedstock conversion facility.

According to an embodiment, a method comprises generation of the heated fluidic medium by at least one rotary apparatus comprising: a rotor with a plurality of rotor blades arranged into at least one row around a rotor hub mounted onto a rotor shaft; a plurality of stationary blades or vanes arranged into an assembly adjacent to the at least one row of rotor blades; and a casing with a duct formed between at least one inlet and at least one outlet, the duct configured to encompass rotating and stationary blades such that bladeless portion(s) of the duct is/are arranged essentially subsequently to bladed portions thereof, wherein the rotary apparatus is configured to impart thermal energy to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated, and wherein the method further comprises: supplying the stream of heated fluidic medium generated by the at least one rotary apparatus into the feedstock conversion facility, and operating said at least one rotary apparatus and said feedstock conversion facility to carry out thermal or thermochemical conversion of carbon-based feedstocks into usable products at temperatures essentially equal to or exceeding about 400 degrees Celsius (° C.).

In embodiments, the method is provided for thermal or thermochemical conversion of essentially solid carbon-based feedstocks.

In an embodiment, in said method, the at least one rotary apparatus is connected, in the feedstock conversion facility, to at least one feedstock conversion unit configured to carry out thermal or thermochemical carbon-based feedstock conversion process or processes at temperatures essentially equal to or exceeding about 400 degrees Celsius (° C.).

In an embodiment, the method comprises supplying the stream of heated fluidic medium generated by at least one rotary apparatus into the at least one feedstock conversion unit within the feedstock conversion facility.

In an embodiment, the method comprises bringing the stream of heated fluidic medium generated by at least one rotary apparatus into contact with carbon-based feedstock in the at least one feedstock conversion unit, wherein said heated fluidic medium generated by at least one rotary apparatus provides heat for thermal or thermochemical conversion of said essentially solid carbon-based feedstocks into usable products.

In an embodiment, the method comprises bringing the stream of heated fluidic medium generated by at least one rotary apparatus into contact with heat transfer material in a heat transfer section of the feedstock conversion unit, and transferring heated heat transfer material from the heat transfer section into a conversion section of the feedstock conversion unit, in which conversion section the heated heat transfer material provides heat for thermal or thermochemical conversion of carbon-based feedstocks into usable products.

In an embodiment, the method further comprises transferring the heat transfer material from the conversion section of the feedstock conversion unit back to the heat transfer section for re-heating, wherein at least a part of said heat transfer material is transferred from the conversion section to the heat transfer section through a purification unit, in which the heat transfer material is purified from unreacted carbon char and coke.

In an embodiment, the heat transfer material is a metal oxide material, and conversion of carbon-based feedstocks in the feedstock conversion unit is accompanied with oxidation-reduction (redox) reactions of said metal oxide material.

In an embodiment, in said method, the processes of heat transfer and conversion are conducted in the feedstock conversion unit in an essentially closed-loop pathway.

In an embodiment, the feedstock conversion unit comprises at least one fluidized bed device. In an embodiment, the at least one fluidized bed device comprises catalyst.

In an embodiment, the method comprises fluidization of carbon-based feedstock with the heated fluidic medium generated in the at least one rotary apparatus.

In an embodiment, the method comprises mixing the the carbon-based feedstock with essentially solid bed material in at least one fluidized bed device. In an embodiment, the essentially solid bed material comprises particulate or powder.

In an embodiment, in said method, the bed material provided in at least one fluidized bed device consists of carbon-based feedstock provided as particulate or powder.

In an embodiment, in said method, the feedstock conversion unit is configured as a dual fluidized bed reactor.

In an embodiment, thermal or thermochemical conversion of carbon-based feedstock is carried out by gasification or by pyrolysis optionally implemented at steam cracking conditions. In an embodiment, the feedstock conversion unit comprises or consist of a gasifier or a pyroliser optionally operated at steam cracking conditions.

In an embodiment, the method comprises supplying the stream of heated fluidic medium generated by the at least one rotary apparatus into the feedstock conversion facility to provide external heat to at least one feedstock conversion unit within said facility.

In an embodiment, in said method, the fluidic medium that enters the rotary apparatus is an essentially gaseous medium. In an embodiment, the heated fluidic medium generated by the at least one rotary apparatus comprises steam (H₂O). In embodiments, the heated fluidic medium generated by the at least one rotary apparatus comprises an oxidative gas, such as air or oxygen gas (O₂), or a combination thereof. In embodiments, the heated fluidic medium generated by the at least one rotary apparatus comprises a non-oxidative gas, such as nitrogen gas (N₂), hydrogen gas (H₂), a hydrocarbon-containing gas, or a combination thereof. In embodiments, the heated fluidic medium generated by the rotary apparatus comprises a recycle gas recycled from exhaust gases generated during feedstock conversion process(es) in the feedstock conversion facility.

In embodiments, the method comprises generation, by at least one rotary apparatus of the fluidic medium heated to any one of (i) temperatures within a range of about 400° C. to about 800° C.; (ii) temperatures within a range of about 800° C. to about 1000° C.; and (iii) temperatures exceeding 1000° C., preferably, provided within a range of about 1000° C. to about 1700° C.

In an embodiment, the method comprises adjusting velocity and/or pressure of the stream of fluidic medium propagating through the rotary apparatus.

In an embodiment, in said method the heated fluidic medium is generated by at least one rotary apparatus comprising two or more rows of rotor blades sequentially arranged along the rotor shaft. In an embodiment, the heated fluidic medium is generated by at least one rotary apparatus, in which the bladeless portion of the duct is arranged downstream of the at least one row of rotor blades.

In an embodiment, in said method, the at least one rotary apparatus is electrically operated, such that electrical energy constitutes about 5 percent to about 100 percent of a total energy consumption by said at least one rotary apparatus. In an embodiment, electrical energy consumed by the at least one rotary apparatus is obtainable from a source of renewable energy or a combination of different sources of energy, optionally, renewable energy.

In an additional or alternative embodiment, the at least one rotary apparatus is configured to receive input energy from a non-electric power source provided as a power turbine and/or a mechanical drive engine, for example.

In an embodiment, the method comprises generation of the heated fluidic medium by at least two rotary apparatuses integrated into the feedstock conversion facility, wherein the at least two rotary apparatuses are connected in parallel or in series.

In embodiments, in said method, the carbon-based feedstock comprises plastic and/or organic material, optionally, plastic and/or organic waste.

In an embodiment, the method comprises pre-treatment of the carbon-based feedstock, wherein pre-treatment comprises size-reduction of feedstock particles carried out through grinding, such as cryogenic grinding.

In a further aspect, an assembly is provided and comprises at least two rotary apparatuses being connected in parallel or in series.

In a further aspect, an arrangement is provided and comprises at least one rotary apparatus, said at least one rotary apparatus being connected to at least one feedstock conversion unit within the feedstock conversion facility.

In a further aspect, a feedstock conversion facility is provided and is configured to implement a feedstock conversion process through a method according to some previously defined aspects and embodiments.

In embodiments, said feedstock conversion facility is configured as a plastic material conversion and/or recycling facility, optionally as a plastic waste conversion and/or recycling facility, and/or as an organic material conversion facility.

The utility of the present invention arises from a variety of reasons depending on each particular embodiment thereof.

Overall, the disclosed method allows for improving existing feedstock conversion methods utilizing fluidized bed technology in terms of at least reducing the number of devices used in the processes, decreasing or eliminating GHG emissions, and improving thermal efficiency of the process.

Thus, integrating rotary apparatus (-es) into feedstock conversion facilities as described herewith, allows for generating heated fluidic medium (to be used in conversion processes) and for fluidizing solid bed material using the same. Hence, the rotary apparatus (-es) integrated into the conversion facility enable provision of process heat and fluidization in a single equipment.

Disclosed method enables inputting thermal energy into heat-consuming utilities, such as conversion reactors or furnaces used in feedstock conversion facilities operating at high—and extremely high temperatures, such as temperatures generally exceeding 400° C. The invention offers apparatuses and methods for heating fluidic substances to temperatures within a range of about 400° C. to about 1700° C. and beyond, up to about 2000° C., i.e. the temperatures used in high-temperature conversion of carbonaceous materials through pyrolysis (oxidative or non-oxidative), gasification or combustion.

Additional or alternative benefits provided by the embodiments include:
Improved fluidization control (in terms of at least temperature and flow parameters);
By heating fluidization gas in the rotary apparatus, additional heat can be introduced directly to feedstock conversion reactions occurring in related (fluidized bed) equipment;
In the disclosed method, incineration of fuel (fossil—or biobased) is avoided; therefore, associated CO₂ and NOₓ emissions, as well as particulate and unburned fossil fuel residues such as coke, soot, PAH and inorganics are not formed, or their formation is significantly reduced compared to conventional methods;
Recycle of off-gases for improving energy-efficiency and reducing or eliminating GHG emissions, thus eliminating the need for complex and costly heat recovery equipment for flue gases;
Improved thermal efficiency of the process (achieved via gas recycle and/or through using electrified rotary apparatus solutions);
Reduced number of purification steps for recycle gas (for re-use in the rotary apparatus);
In indirect gasification, coke or carbon residues formed on heating medium material surface(s) can be separated therefrom by mechanical methods, leaching or other non-burning means.

In embodiments, the rotary apparatus can be further used to replace conventional fuel-fired heaters or burners in conversion processes. By integrating rotary apparatus into feedstock conversion facility operating as a fluidized bed gasification facility, for example, the need in directing auxiliary fuels into gasification and/or combustion process (-es) is eliminated fully or partly, and flue gas emissions are reduced, accordingly. Replacement of fuel-fired burners with rotary apparatus (-es) allows for reducing greenhouse gas-(CO, CO₂, NOₓ) and particle emissions. Additionally, with the rotary apparatus it is possible to build closed or semi-closed heating loops for conversion processes through recycling flue gases. Above mentioned scenarios can be implemented with rotary apparatus (-es) operating with electric energy as input energy and/or configured to receive input energy from a non-electric power source, such as a power turbine and/or a mechanical drive engine, for example. With recycling loops, flue gas-associated heat losses are reduced, and the energy efficiency of conversion processes is improved. On the contrary, in conventional processes flue gases can be recycled only partly.

The invention further provides for flexibly using electrical energy, such as electrical energy obtainable from renewable sources. Production of renewable energy varies on daily basis and even on hourly basis. The invention allows for balancing renewable electricity production by integration of the rotary apparatus disclosed herewith with conventional fuel-operated (fuel-fired) burners to provide heat to feedstock conversion processes.

The expression “a number of” refers hereby to any positive integer starting from one (1), e.g. to one, two, or three. The expression “a plurality of” refers hereby to any positive integer starting from two (2), e.g. to two, three, or four. The terms “first” and “second”, are used hereby to merely distinguish an element from another element without indicating any particular order or importance, unless explicitly stated otherwise.

Different embodiments of the present invention will become apparent by consideration of the detailed description and accompanying drawings.

### BRIEF DESCRIPTION OF THE DRAWINGS

FIGS. 1A and 1B schematically illustrate systems and methods for direct and indirect gasification, respectively, according to the embodiments.

FIGS. 2A and 2B schematically illustrate systems and methods for direct and indirect pyrolysis, respectively, according to the embodiments.

FIG. 3 is a schematic representation of a fluid catalytic cracking (FCC) facility and method, according to the embodiments.

FIG. 4 is a schematic representation of a chemical loop gasification facility and method, according to the embodiments.

FIGS. 5A and 5B schematically illustrate systems and methods for direct and indirect gasification, respectively, known from the prior art.

### DETAILED DESCRIPTION OF THE EMBODIMENTS

Herein disclosed is a method for thermal or thermochemical conversion of carbon-based (carbonaceous) feedstocks into usable products in a feedstock conversion facility. Additionally, devices and systems configured to implement thermal or thermochemical conversion within the related facility are disclosed.

Carbon-based feedstocks comprise or consist of fossil-derived feedstocks, such as plastic feedstocks, and/or organic feedstocks, such as biomass-derived feedstocks. In embodiments, carbon-based feedstocks comprise or consist of plastic waste, organic waste or both (e.g. biodegradable plastics). The term “waste” relates, in present disclosure, to any waste material and/or any non-usable by-product generated as a result of a process or production that is no longer deemed valuable and is therefore normally discarded. In embodiment, waste feedstocks are mainly or fully composed of solid waste.

Plastic feedstocks may comprise any type of plastics, such as for example consumer plastic waste (originating from households, leisure and sports, for example) and/or industrial plastic waste arising from a variety of industries including, but not limited to packaging, building and construction, automotive and agriculture. Exemplary plastic feedstocks comprise polyolefins, such as polyethylene (PE), including high-density polyethylene (HDPE) and low-density polyethylene (LDPE), and polypropylene (PP), aromatics, such as polystyrene (PS) and expanded polystyrene, polyvinyl chloride (PVC), ethylene-vinyl acetate (EVA), ethylene vinyl alcohol (EVOH), polyethylene terephthalate (PET), or any combinations thereof.

The term “organic feedstocks” is used in the present disclosure to indicate feedstocks of substantially biological origin produced for example in agriculture, farming, paper industry, food and beverage industry, and households. In embodiments, organic feedstocks include biomass, optionally waste biomass, and/or biomass-derived feedstocks including, but not limited to field (plant) biomass and by-products (bagasse, bran, straw), kitchen—and catering (bio) waste, household—and/or municipal waste, by-products of food industry, forestry, agriculture (farming, animal—and poultry rearing), as well as sewage slurries and wastewater sludge.

Overall, the present invention covers utilization of any carbon-based waste feedstock, which can be converted to usable products. The invention is also applicable to utilization of hazardous waste materials, such as contaminated land, to be decomposed safely.

In the disclosed method, carbon-based feedstocks are converted into one or more usable products. In embodiments, usable products comprise solids (e.g. recycled plastics), hydrocarbon containing gases, such as olefins, fuels and chemicals, synthesis gas (syngas), (bio) char, (bio) oil, as well as heat and electricity. In embodiments, the method comprises recycling of carbon-based feedstocks into valuable products, such as raw materials for manufacturing of (recycled) plastic goods.

The disclosed method comprises heating a stream of fluidic medium by at least one rotary apparatus (described further below); supplying the stream of heated fluidic medium to the feedstock conversion facility; and operating the at least one rotary apparatus and feedstock conversion facility to carry out thermal or thermochemical conversion of carbon-based feedstocks into usable products at temperatures essentially equal to or exceeding about 400 degrees Celsius (° C.).

In embodiments, thermal or thermochemical conversion processes or processes comprise(s) any one of: gasification, combustion, pyrolysis, or a combination thereof. In embodiment, pyrolysis includes steam cracking.

Combustion is a thermochemical process, where carbon-based substances, sometimes referred to as fuels, react with oxygen (O₂) to produce water vapour (H₂O) and exhaust gases, such as carbon dioxide (CO₂), nitrogen oxides (NOx) and sulphur oxides (SOx). Oxidation reaction is exothermic and generates an excess of heat.

Gasification is a thermochemical process that converts carbon-based substances, such as for example coal, biomass, plastic waste, or fossil hydrocarbons, into syngas (a mixture of H₂ and CO), which can further be used as raw material for synthesis of industrially relevant base chemicals and raw materials, such as methanol, ethanol or Fischer-Tropsch hydrocarbons. Dependent on feedstock and reaction conditions, the product gas may further include gaseous nitrogen (N₂), minor amounts of ammonia (NH₃), as well as traces of hydrogen sulfide (H₂S) and hydrogen chloride (HCl). The ratio between hydrogen and carbon monoxide in syngas depends on gasification technology and raw materials and can be adjusted using water-gas shift reaction or hydrogen addition. Unlike combustion, gasification reactions are endothermic and require external heat.

Gasification reactions occur at elevated temperatures (800-1200° C.) with controlled amount of oxygen. The process is also referred to as a partial oxidation of carbon-based feedstocks, which means that feedstock carbon is reacted with limited amount of oxygen, i.e. less oxygen is used in gasification than in combustion (complete oxidation). Restricted oxygen supply is needed to produce carbon monoxide, in particular, when oxygen-rich organic matter, such as biomass, is used as feed. Typical gasification agents include air, oxygen and/or steam.

Simplified gasification chemistry of various feedstocks is described with Equations 1-7, where Equation 1 is a direct gasification of coal:

$$C + \frac{1}{2} {O}_{2} \to CO \qquad ( 1 )$$

Equation 2 is an indirect gasification of coal:

$$C + {H}_{2} O \to CO + {H}_{2} \qquad ( 2 )$$

Equation 3 is devolatilization of biomass, whereupon biomass feed is decomposed under heating, and volatiles are driven out from the biomass feed

$$Biomass ( {C}_{6} {H}_{12} {O}_{6} ) \to {C + C O + {H}_{2} + {H}_{2} O + C {O}_{2} + CH}_{4} + {C}_{n} {H}_{m} \qquad ( 3 )$$

Equations 4a and 4b continue from Eq. 3 and represent direct gasification of biomass:

$$C + \frac{1}{2} {O}_{2} \to CO \qquad ( 4 a )$$

$${CH}_{4} + \frac{1}{2} {O}_{2} \to CO + 2 {H}_{2} \qquad ( 4 b )$$

Equations 5a-5c continue from Eq. 3 and represent indirect gasification of biomass:

$$C + {H}_{2} O \to CO + {H}_{2} \qquad ( 5 a )$$

$${C}_{n} {H}_{m} + n {H}_{2} O \to ( n + m / 2 ) {H}_{2} + n CO \qquad ( 5 b )$$

$$C {H}_{4} + {H}_{2} O \to CO + 3 {H}_{2} \qquad ( 5 c )$$

Equation 6 represents direct gasification of plastic feedstocks:

$$- {CH}_{2} - \frac{1}{2} {O}_{2} \to C O + {H}_{2} \qquad ( 6 )$$

Equation 7 represents indirect gasification of plastic feedstocks:

$$- {CH}_{2} - + {H}_{2} O \to CO + 2 {H}_{2} \qquad ( 7 )$$

As can be seen from equations above, indirect gasification always produces syngas richer in hydrogen. This is useful for syngas conversion reactions such as synthesis of methanol (Eq. 8) and synthesis of Fischer-Tropsch hydrocarbons (Eq. 9). This is because boosting hydrogen content in syngas requires either addition of costly hydrogen or conversion of carbon monoxide into hydrogen via Water-Gas Shift (WGS) reaction (Eq. 10). The latter produces unwanted carbon dioxide which is environmentally harmful and has to be removed from product gas.

Equation 8 represents a process of methanol synthesis:

$$CO + 2 {H}_{2} \to C {H}_{3} OH \qquad ( 8 )$$

Equation 9 represents a process of Fischer-Tropsch synthesis of hydrocarbons:

$$CO + 2 {H}_{2} \to - {CH}_{{2}^{-}} + {H}_{2} O \qquad ( 9 )$$

Equation 10 represents Water-Gas Shift (WGS) reaction of carbon monoxide:

$$C O + {H}_{2} O \to C {O}_{2} + {H}_{2} \qquad ( 10 )$$

Pyrolysis is a process of thermal/thermochemical (endothermic) conversion of carbon-based feedstocks into gaseous, liquid and solid products. In present disclosure the term “pyrolysis” is used to describe conversion process in an oxygen-free environment, i.e. in an absence of any one of air, oxygen and/or steam, and occurring at temperatures within a range of about 400-500° C. to about 800° C. In some instances, pyrolysis proceeds in presence of steam, and the process is then referred to as “steam cracking”. In steam cracking conditions, temperature of the pyrolysis process is elevated to the temperatures exceeding typical pyrolysis conditions (i.e. above >800° C., typically within a range between about 800° C. to about 1000° C.), whereupon carbon-based feedstock vaporizes, where vaporization is optionally preceded with melting, and cracks to produce light olefins, such as ethylene and propylene. In some instances, such as when the carbon-based feedstock is plastic, for example, also vaporization step can be omitted, and the plastic feedstocks undergo cracking reactions at the above indicated temperatures to yield light olefins.

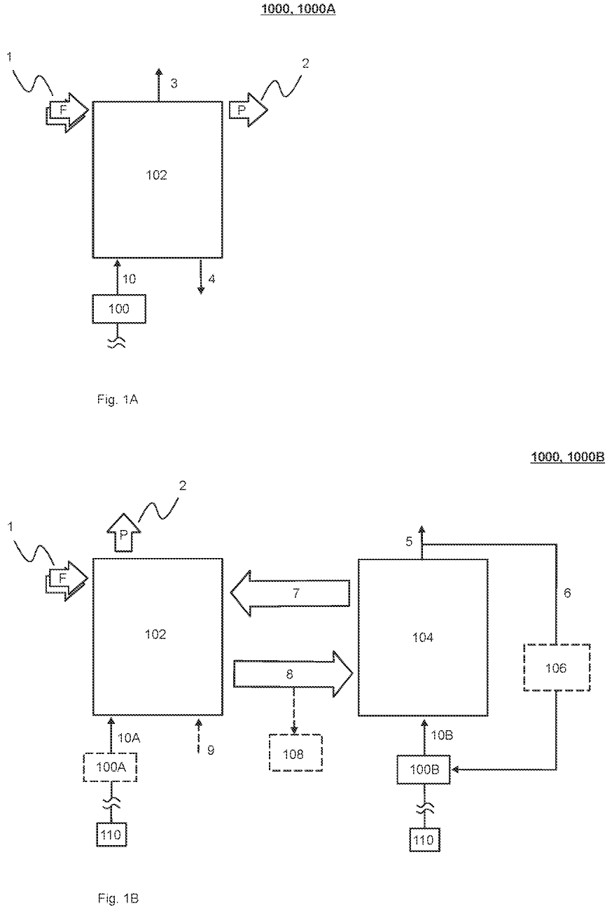

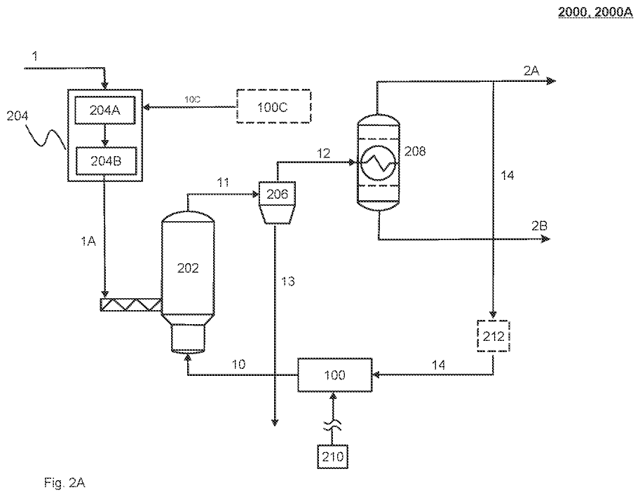

FIGS. 1-4 schematically illustrate exemplary layouts for a feedstock conversion facility 1000, 2000, 3000, 4000 configured to implement the method according to the embodiments. Figures and related examples serve illustrative purposes and are not intended to limit applicability of the inventive concept to the layouts expressly presented in this disclosure. Block diagram sections shown by dotted lines are optional.

In embodiments, facility 1000, 2000, 3000, 4000 is configured to carry out thermal or thermochemical conversion of carbon-based feedstocks into usable products at temperatures within a range of about 400° C. to about 1700° C. In embodiments, facility 1000, 2000, 3000, 4000 is configured as a pyrolysis facility configured to carry out thermal or thermochemical conversion of carbon-based feedstocks into usable products in non-oxidative conditions at temperatures within a range of about 400-500° C. to about 800° C. In embodiments, facility 1000, 2000, 3000, 4000 is configured as a steam cracking facility configured to carry out thermal or thermochemical conversion of carbon-based feedstocks into usable products in present of steam at temperatures within a range of about 800° C. to about 1000° C. In embodiments, facility 1000, 2000, 3000, 4000 is configured as a gasification facility configured to carry out thermal or thermochemical conversion of carbon-based feedstocks into usable products at temperatures within a range of about 800° C. to about 1700° C., in some instances, within a range of about 800° C. to about 1200° C. In some configurations, gasification may be carried out at temperatures within a range of about 1000° C. to about 1200° C. In embodiments, facility 1000, 2000, 3000, 4000 is configured to utilize fluidized bed equipment.

The feedstock conversion facility 1000, 2000, 3000, 4000 comprises at least one feedstock conversion unit configured to carry out thermal or thermochemical carbon-based (carbonaceous) feedstock conversion process or processes at temperatures essentially equal to or exceeding about 400 degrees Celsius (° C.). In embodiments, the feedstock conversion unit comprises or consists of a conversion device or a group of devices implemented as a gasification reactor or a pyrolysis reactor. In additional or alternative embodiments, the feedstock conversion unit comprises a pyrolysis reactor configured to operate at steam cracking conditions. In embodiments, the feedstock conversion unit further comprises a regenerator (a combustor). Hence, in embodiments, the feedstock conversion unit comprises or consists of a gasifier, a pyroliser, a combustor, or a combination thereof. In the facility, said feedstock conversion unit(s) is/are connected to at least one rotary apparatus 100 in a way that enables supplying the stream of heated fluidic medium generated by the rotary apparatus (-es) into the feedstock conversion unit or units. Suitable connection means include piping with appropriate connectors, valves, controller, e.g. pressure controllers, and the like.

In embodiments, the feedstock conversion unit comprises or consists of a device or devices comprising a bed of particulate solid material. Particulate materials are mechanical mixtures of multitude of solid particles. Any suitable type of bed matrix (natural or synthesized) may be utilized. Suitable natural particulates include those originating from many long-term natural processes, such as heating, cooling, atmospheric changes, water erosion, etc. Solid particulates may also be synthesized/produced in technological processes, such as grinding, milling, evaporation, crystallization, spraying, drying, etc. Some exemplary bed materials may include mineral particulates (e.g. olivine, quartz), sand, ash, etc.

In embodiments, the feedstock conversion unit comprises or consists of a device or devices utilizing fluidized bed technology. The device(s) is/are then configured as fluidized bed reactor (FBR) device(s). Overall, FBR device(s) of the feedstock conversion unit may follow any conventional gas-solid equipment design adapted to carry out mass and/or heat transfer processes between gaseous fluids and a bed of substantially solid material. In different configurations, the FBR reactor(s) may be provided as any one of a stationary (fixed) fluidized bed reactor, a bubbling fluidized bed reactor, a circulating fluidized bed reactor, an entrained fluidized bed reactor, or a counter-current fluidized bed reactor. The latter may be provided with a downwards solid flow towards the gas flow.

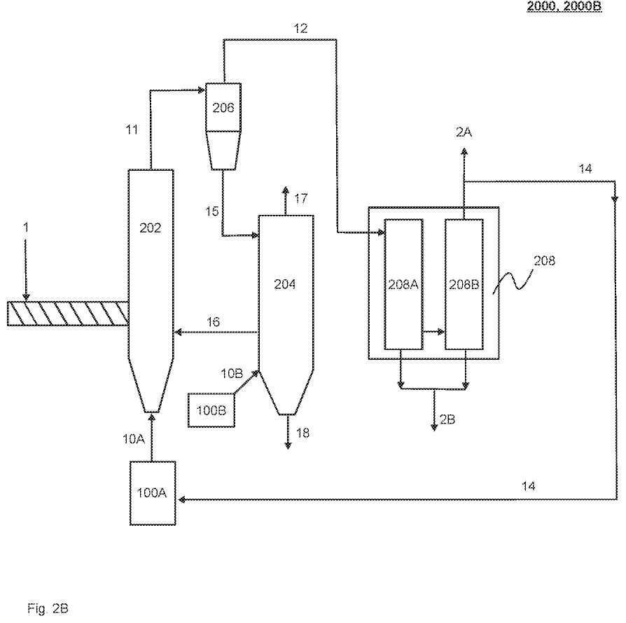

In embodiments, the disclosed method comprises bringing a stream of heated fluidic medium generated by at least one rotary apparatus into contact with the carbon-based feedstock in the conversion reactor, thus providing heat of reaction necessary for converting said feedstock into usable product(s). The approach is recognized as direct conversion of feedstocks and described in relation to FIGS. 1A and 2A.

In some other embodiments, the disclosed method comprises bringing the stream of heated fluidic medium generated by at least one rotary apparatus into contact with a matrix of heat transfer material in a heat transfer (regeneration) section of the feedstock conversion unit and transferring heated heat transfer material from said heat transfer section into a conversion section of the feedstock conversion unit, in which conversion section the heated heat transfer material provides heat for thermal or thermochemical conversion of carbon-based feedstocks into usable products. The approach is recognized as indirect conversion of feedstocks and is described in relation to FIGS. 1B and 2B.

In both direct and indirect approaches, conversion of feedstock(s) may be realized in a conversion reactor via gasification or pyrolysis processes. In some instances, pyrolysis setup may be operated at steam cracking conditions.

The feedstock conversion units/devices described hereinbelow may be configured to implement any one of thermal and/or catalytic conversion processes.

FIG. 1A is a basic implementation 1000A of the facility 1000 comprising a feedstock conversion unit implemented as a gasifier 102, and a rotary apparatus 100. In the layout of FIG. 1A, the conversion unit is a gasification reactor 102 adapted for conversion of carbon-based feedstock 1 via (direct) gasification.

In embodiments, the disclosed method for conversion of carbon-based feedstock into usable products comprises bringing a stream of heated fluidic medium 10 generated by at least one rotary apparatus 100 into contact with the carbon-based feedstock 1 in the gasification reactor 102 to usable products 2. In embodiments, the gasification reactor 102 is adapted for production of syngas 2 from carbon-based feedstocks.

In embodiments, the gasifier 102 is a fluidized bed reactor (FBR) operating based on any appropriate fluid-solid base technology outlined hereinabove.

In embodiments, the fluidic medium 10 heated in the rotary apparatus 100 is steam (H₂O). Steam provides heat necessary for (direct) gasification of feedstocks in the fluidized bed gasification reactor 102 and at the same time it acts as a fluidization agent. Compared to air, steam as a gasification/fluidization agent produces nitrogen-free product gas, therefore, complex and expensive separation of nitrogen from the syngas product is avoided.

Hence, in particular in direct gasification, air can be replaced with hot steam (H₂O, 1000-1700° C.) generated in the rotary apparatus 100. Hot steam fluidizes the bed and provides the heat of reaction for endothermic gasification processes. Resulting syngas is richer in hydrogen than that formed in partial oxidation (with air/oxygen) and contains no nitrogen, which is advantageous for subsequent syngas conversion reactions, such as Fischer-Tropsch synthesis of hydrocarbons, synthesis of methanol, and the like (see Equations 8 and 9). Production of hydrogen-rich syngas allows for avoiding such energy- and cost-consuming steps, as addition of hydrogen into syngas in post-processing and/or producing hydrogen according to WGS reaction pathway (see Equation 10). When steam is used as a gasification/fluidization agent, no CO₂ emissions is produced during gasification process, unlike in air/oxygen blown processes. Water can then be condensed from the final syngas product in a cooling device, such as a heat exchanger, for example, arranged downstream of the gasifier 102 (not shown). Using steam instead of oxygen also increases hydrogen content of the syngas product, which is beneficial for many of its downstream conversion processes, such as methanol production.

In exemplary configuration of FIG. 1A, optionally pre-heated (not shown) steam 10 enters the rotary apparatus 100. In the rotary apparatus, steam is heated to operating temperature, which for gasification is essentially equal to or above about 800° C., in some instances-equal or above about 1000° C. (i.e. temperature at exit of the rotary apparatus is about 1000-1700° C.) and supplied into the gasification reactor 102 containing a bed of solid material. Steam 10 brings heat necessary for conversion of feed into product syngas 2 and at the same time fluidizes the bed material. Syngas can be sent for post-processing and/or for use. Flue gas 3 is purged out of the reactor, and solid residue (SR) 4 is withdrawn for disposal.

FIG. 1B shows integration of the rotary apparatus 100 into a facility 1000, 1000B for indirect gasification of essentially solid carbonaceous feedstocks. Facility 1000B comprises a feedstock conversion unit with a feedstock conversion section and a heat transfer (regeneration) section. In embodiments, the feedstock conversion section is represented with a conversion reactor 102 embodied as a gasification reactor, and the heat transfer (regeneration) section is represented with a regenerator device 104. Regenerator device 104 is realized as a combustion reactor (a combustor). At least one rotary apparatus 100 may be configured to supply heated fluidic medium to gasification reactor 102 or combustion reactor 104, or both. In the layout of FIG. 1B, the rotary apparatus 100 in connection with the gasification reactor 102 is designated with reference numeral 100A, and the rotary apparatus 100 in connection with the combustion reactor 104—with reference numeral 100B.

In embodiments, the disclosed method for conversion of carbon-based feedstock into usable products comprises bringing the stream of heated fluidic medium generated by at least one rotary apparatus into contact with a matrix of bed material in the combustion reactor 104 and transferring a heated matrix of bed material (stream 7) from combustion reactor 104 into gasification reactor 102, in which said bed material provides heat for thermal or thermochemical conversion of carbon-based feedstocks into usable products via gasification. Bed material thus acts as heat transfer material. Cold bed material is returned (stream 8) back to the combustor 104. Bed matrix is circulated between the reactors 102, 104 essentially continuously. A closed-loop route is thus formed notwithstanding supplying make-up bed material into the reactor(s), and/or withdrawal of contaminated bed material (not shown), in which the processes of heat transfer (in the combustor 104) and feedstock conversion (in the gasifier 102) are conducted concurrently.

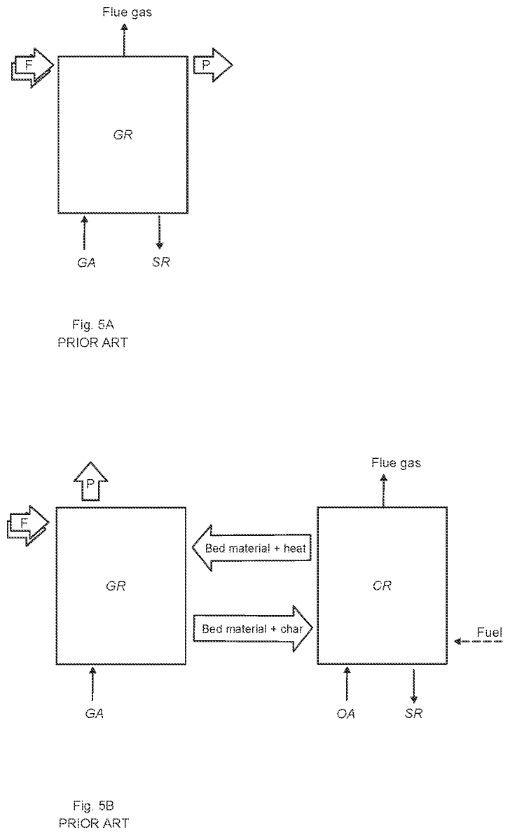

In embodiments, the feedstock conversion unit comprising reactor devices 102, 104 is configured as a dual fluidized bed (DFB) gasifier. Interconnected reactor devices 102, 104 provided within the DFB unit may follow any conventional design and operate as generally described with reference to FIG. 5B.

In an exemplary DFB system shown on FIG. 1B, a stream 10A, 10B of heated fluidic medium 10 generated by rotary apparatuses 100A, 100B respectively is directed to the gasification reactor 102 and the combustion reactor 104. In the DFB system, apparatus 100A that supplies the heated fluidic medium into gasification reactor 102 generates heated steam (stream 10A), in the same manner as discussed in relation to FIG. 1A. 10. Steam generated by the apparatus 100A and blown into a bulk of bed material in the gasification reactor 102 acts as a fluidization agent to fluidize carbonaceous feed the reactor 102. On the other hand, fluidic medium 10B generated by the rotary apparatus 100B can be chemically inert gas, e.g. nitrogen (N₂). Fresh inert gas supplied into the rotary apparatus 100B from a gas source 110 may be combined with the recycled flue gas (stream 6). The arrangement may further include an (optional) flue gas purification unit 106 to purify flue gases 6 before they enter the apparatus 100. The unit 106 may be configured as a hot filtration unit for example.

Rotary apparatuses 100A, 100B are configured to heat fluids/gases 10A, 10B received therein to at least 800° C. (exit temp), and preferably to any temperature within a range of 800-1700° C. More than one rotary apparatus 100 can be connected to the same reactor 102, 104 (not shown).

Additional fuel optionally supplied into the gasification reactor 102 is designated with reference numeral 9.

In the layout of FIG. 1B, hot inert gas 10B may be used to replace fuel and air in the combustion reactor 104. Carbon dioxide emissions are thus not formed, and combustor flue gases can be recycled, at stream 6, for optimal heat recovery. However, in an event the rotary apparatus 100B supplies heated inert gas into the combustor for heating, unreacted char and coke normally “recycled” into the combustor with the cold bed of material 8 are not incinerated and remain in bed material. Therefore, mechanical separation of carbon char and coke from the bed material 8 is needed between gasification reactor 102 and combustion reactor 104. Hence, in some configurations, at least a part of bed material 8 is directed to a purification unit 108, where unreacted char and coke are removed from the bed matrix.

In some other configurations, all bed material is conveyed to the combustion reactor 104 for re-heating. Provision of the bed material purification unit 108 may thus be optional when some air and/or oxygen is added to the stream of fluidic medium 10B heated in the rotary apparatus 100B for combusting unreacted char and coke in the combustor 104. This configuration is particularly suitable for gasification of organic feedstocks, such as biomass, where emissions resulting from combusting char/coke would be biogenic. Still further alternative for coke and emission management is to use steam as a feed medium for the rotary apparatus 100B (stream 10B). Steam would react in the combustor 104 with char/coke at high temperatures and form a mixture of carbon monoxide and hydrogen according to the following equation:

$$C + {H}_{2} O \to CO + {H}_{2} \qquad ( 11 )$$

Carbon monoxide and hydrogen formed in the reaction may undergo further valorization, which would improve overall material efficiency of gasification process. In a latter case, one rotary apparatus may be configured to supply stream for both reactors 102, 104.

In some configurations, flue gas may be purged, at stream 5, out of the combustor 104.

FIGS. 2A and 2B illustrate basic embodiments of a method for thermal or thermochemical conversion of carbon-based feedstocks into usable products via pyrolysis in a feedstock conversion facility 2000 configured to implement the methods of direct pyrolysis (2000A, FIG. 2A) and indirect pyrolysis (2000B, FIG. 2B).

Facility 2000A (FIG. 2A) comprises a feedstock conversion unit implemented as a pyroliser 202, and at least one rotary apparatus 100. In the layout of FIG. 2A, the unit conversion unit is a pyrolysis reactor adapted for direct gasification of feedstock 1. In embodiments, the reactor 202 is adapted for pyrolysis of organic feedstock(s). In some embodiments, the reactor 202 is adapted for pyrolysis of biomass to produce results liquid, solid and gaseous fractions, mainly gases, bio-oil and char.

In embodiments, facility 2000A may be modified for (direct) pyrolysis of plastic feedstocks. In embodiments, the facility 2000A is adapted for pyrolysis of plastic waste. Pyrolysis of plastic waste typically results in a mixture of gas, liquid, wax and solid product. Ratios of these product fractions can be adjusted by altering process conditions, such as pyrolysis temperature, pressure and residence time in the reactor 202.

In the layout of FIG. 2A, the stream of heated fluidic medium 10 generated by at least one rotary apparatus 100 is contacted with feed in the conversion reactor 202. Herein, the conversion reactor 202 is configured as a pyrolysis reactor 202. The reactor 202 can be configured as a fluidized bed reactor of any suitable type described herein above. Since the heat of reaction is delivered into the reactor 202 via a fluidizing gas 10, implementation of a fluidized bed consisting of solid feedstock particles is possible. It may be preferred that particle size of the solid feedstock is sufficiently small to allow necessary heat transfer from the hot fluidic stream 10 to feedstock in the reactor 202 and hence to enable sufficient conversion of feedstock into products.

Therefore, the process may include pre-treatment of feed 1 in a pre-treatment unit 204, where feed is dried (204A) and size-reduced (204B) through grinding, for example.

Overall, the conversion method and facility layout presented herewith allows for utilization of feedstock particles of significantly smaller size than that used in conventional setups. In conventional pyrolysis processes, the feed is introduced into pyrolysis reactor in the form of pellets or through an extruder. Coarse feedstock particles require longer times to be pyrolyzed, leading to occurrence of secondary reactions which typically yield pyrolysis oils instead of gaseous products. By using smaller feedstocks particles, an amount of side reactions can be reduced.

The pre-treatment facility 204 may further include a cryogenic chamber (not shown). This is advantageous in treating plastic waste, which is typically a very soft material, in particular if it contains a share of so-called 2D-plastic e.g. plastic films made of high-density polyethylene (HDPE) and similar polymers. Grinding of such material at room temperature is not possible, due to material elasticity. This can be overcome by cryogenic treatment of the plastic waste feed, whereupon the feed is cooled down to cryogenic temperatures (e.g. down to minus 100° C.) that reduces elasticity of the material and makes it grindable. Cryogenic treatment enables grinding feed material into very fine powder that improves heat transfer between the particles and hot fluidization gas 10.

In additional or alternative configurations, the pre-treatment facility 204 can comprise an extruder, where essentially solid feedstock material(s), such as for example plastic, is/are melted prior to enter thermal or thermochemical conversion in the pyrolysis reactor 202.

Pre-treated feed 1A is subjected to thermal or thermochemical conversion in the pyrolysis reactor as a result of being contacted with hot fluidic medium 10 supplied from the rotary apparatus 100. Depending on reaction conditions and feedstock, the temperature of fluidic medium 10 supplied into the pyrolysis reactor 202 is within a range of about 400° C. to about 800° C. The rotary apparatus 100 provides the heat of (pyrolysis) reaction by blowing hot fluidizing gas 10 into the reactor 202.

Pyrolysis process typically takes place in non-oxidative conditions, therefore, presented configuration preferably utilizes inert, non-oxidative gases, such as nitrogen or hydrocarbon-containing gases, as fluidizing gas (-es) 10.

After the reactor 202, an (unprocessed) product stream 11 is directed to a separation unit 206, where process fluids (vapors and gases) are separated from entrained solids, such as char and ash. Separation 206 may be carried out in a series of cyclones, in a hot filtration unit, and/or any other suitable equipment. After separation, a volatile fraction 12 containing pyrolysis vapors is directed to condensation and recovery 208 in order to recover liquid product, while carbon-containing solid fraction 13 (char, ash. etc.) is collected for recycling or disposal. Condensation is typically carried out in multiple stages, which may employ a variety of condensation means and temperature (not shown). In condensation, product gases 2A and liquids 2B are recovered and sent for further refining or use. Thus, pyrolysis of biomass produces so-called “bio-gas” and “bio-oils” which can be further used as alternative, renewable fuels.

A portion of product gas stream and/or flue gases may be recycled, at stream 14, back to the rotary apparatus 100, optionally, via an air blower/system fan arrangement 212. In configurations where the fan 212 is omitted, the recycle gas fan duty is provided by the rotary apparatus 100. Additionally or alternatively, fresh gas is supplied into the apparatus 100 from a suitable source or sources 210.

In some configurations, an additional rotary apparatus 100 (100C) may be installed into the facility to provide heat for drying feedstocks in the pre-treatment facility 204. Hot gas 10C generated in the apparatus 100C may be supplied into any one of drying (204A) or grinding (204B) units, or both.

Typically, in plastic waste pyrolysis process feed is introduced in the form of pellets or trough extruder to pyrolysis reactor. These leads to longer reaction time in pyrolysis and increase of secondary reactions and formation of pyrolysis oil and loss of olefins. If the size of plastic particle is fine powder pyrolysis of particle is significantly smaller and amount of side reactions is reduced.

In embodiments, the pyrolysis reactor 202 may be set up to operate at steam cracking conditions. In the layout 2000A (FIG. 2A) this can be achieved by using steam as a fluidization agent 10. Steam pyrolysis can be advantageously applied for thermal/thermochemical conversion of plastic (waste) feedstocks into usable products, such as gaseous olefins. In steam cracking conditions, the temperature of the fluidizing gas 10 is elevated to temperatures above typical pyrolysis conditions, namely, above 800° C. Steam cracking is typically carried out at temperatures within a range of about 800° C. to about 1000° C. At these temperatures, plastic feed starts to thermally crack into olefins. In comparison to non-oxidative pyrolysis, yielding liquids along with gas, in described oxidative pyrolysis conditions (implemented via steam cracking), no liquid product is produced, and the main product is formed as a gaseous product. Steam cracking of plastic feed thus produces olefin-containing gas (-es). In optimized conditions this will lead to high ethylene and propylene yields in cracked gas. This will necessitate a quench operation after the pyrolysis reactor 202 for rapidly cooling the cracked (product) gas in order to stop cracking reactions and avoid formation of heavier hydrocarbons from reactive olefins and diolefins in the cracked gas. A quench cooler may thus be arranged between the pyrolysis reactor 202 and cyclones 206 (not shown).

Overall, integration of the rotary apparatuses 100 into the plastic feed conversion facility via pyrolysis in non-oxidative or oxidative conditions (via steam cracking) is associated with a number of process-specific benefits. For example, generation of heated fluidic medium 10 in the apparatus 100 allows for packing the pyrolysis reactor with a bed of material consisting of finely grinded solid feedstocks particles (provision of a heat transfer bed material may thus be omitted). Size of feedstock particles is considerably reduced compared to that used in conventional pyrolysis reactors. In steam cracking conditions, this allows for reducing the rate of secondary reactions and improving the yield target olefins, respectively. Pyrolysis reactor can be designed for optimum residence time and temperature and there is no need for heat transfer bed. Due to smaller particle size, heavy impurities common in plastic waste, for example, simply fall to the bottom of the pyrolysis reactor 202, which facilitates their removal.

FIG. 2B illustrates a feedstock conversion facility 2000, 2000B for indirect pyrolysis of essentially solid carbonaceous feedstocks. Facility 2000B operates similarly to the facility 1000B shown on FIG. 1B. It is further noted that facility 1000B (FIG. 1B) can be adapted to implement pyrolysis processes instead of gasification processes.

With reference to FIG. 2B, facility 2000B comprises a feedstock conversion unit with a feedstock conversion section and a heat transfer (regeneration) section. Similarly to gasification setup of FIG. 2B, the conversion section is represented with a conversion reactor 202, and the heat transfer section is represented with a regenerator device 204. In the facility 2000B, the conversion reactor 202 is a pyrolysis reactor, and the regenerator device 204 is a combustion reactor (a combustor). Heated fluidic medium 10 is generated in at least one rotary apparatus 100 and supplied to any one of pyrolysis reactor 202, combustion reactor 204 or both. In the layout of FIG. 2B, the rotary apparatus 100A is configured to supply heated fluidic medium, at stream 10A, to the pyrolysis reactor 202; and the rotary apparatus 100B is configured to supply heated fluidic medium, at stream 10B, to the combustion reactor 202.

The feedstock conversion unit comprising reactor devices 202, 204 may follow the dual fluidized bed (DFB) design as described with regard to FIG. 1B. Heat of reaction required for conversion of feedstock(s) in pyrolysis reactor 202 is delivered with a matrix of bed material transferred into the pyrolysis reactor 202 from the combustion reactor 204 (stream 16). By way of example, a matrix of inert bed material, e.g. sand, is circulated between the reactors 202 and 204 (see streams 15 and 16). It is noted, that compared to direct pyrolysis applications (FIG. 2A), the feedstock solid(s) are not used as bed material, i.e. separate bed material matrix is utilized. Feed 1 supplied into the reactor via an extruder and/or a conveyor, for example, undergoes pyrolysis in the reactor 202 by being contacted with hot matrix of bed material delivered into the pyrolysis reactor 202, at stream 16, from the combustor 204. Heat of combustion thus heats the fluidized bed of material to temperatures required for conversion reactions to occur in the reactor 202. Bed material thus acts as a heat transfer material.

Facility 2000B may be adapted for conversion of any type of suitable carbon-based feedstock, e.g. organic feedstocks, such as biomass, or plastic feedstocks, into gases, liquids and/or solids.

After the reactor 202, the product stream 11 undergoes separation in the separation unit 206 (including cyclones, filters, and the like), in where volatile fractions (vapors and gases) are separated from a solid fraction (a mixture of bed material with carbon char, ash, etc.). Solid fraction is directed, at stream 15, to the combustion reactor 204 for re-heating. Unreacted char and ash can be withdrawn (stream 18) from the combustor for recycling or disposal, while the re-heated bed matrix is transferred into the pyrolysis reactor 202 and the process continues following an essentially closed-loop pathway.

Volatile fraction 12 produced is sent from the separation unit 206 to condensation and recovery 208. Recovery of liquids may be implemented via quench cooling 208A (in a suitable heat exchanger or the like) followed with precipitation 208B (in an electrostatic precipitator or other suitable precipitation unit). It is noted that similar equipment 208A, 208B may be integrated into the layout of FIG. 2A. Gaseous product 2A recovered in the unit 208 is collected and sent for refining, export or flare, while liquid product 2B, such as bio-oil or pyrolysis oil, is collected and sent for further refining or export/use. Flue gases may be recycled, at stream 14, to the rotary apparatus 100A, optionally, via a fan arrangement (not shown). Additionally, flue gases 17 generated in combustion can also be recycled through the stream 14 (not shown). Provision of complex and costly heat recovery equipment for flue gas may thus be avoided.

In the DFB system, pyrolysis reactor 202 utilizes a matrix of solid heat transfer material to heat up feedstock particles 1. In addition to heat transfer material, fluidized bed reactors require a fluidization gas which is introduced into the reactor. Fluidic medium heated by the rotary apparatus 100 and supplied into the DFB system may be used as any one of a fluidization medium (e.g. steam 10A when supplied into the pyrolysis reactor) or as an oxidizing gas (e.g. air, 10B) when used in combustion 204.

It is further noted, that dependent on temperature conditions and a fluidization gas used in the conversion reactor 102 (FIG. 1B), 202 (FIG. 2B), the DFB system may be configured for gasification or pyrolysis. The latter may further operate at steam cracking conditions.

Overall, the DFB system 102, 104 (FIG. 1B) and 202, 204 (FIG. 2B) implements high-temperature conversion processes that use fuel incineration for energy provision. Fuel is incinerated in the combustor 104, 204 together with carbon char formed in pyrolysis reactions. In the method presented herewith, external fuel firing may be replaced with high-temperature fluidic medium generated in the rotary apparatus 100 (100B, FIGS. 1B and 2B) and supplied into the combustor 104, 204. Integrating rotary apparatus (-es) into DFB systems and processes would allow for at least partial electrification of conversion process (-es). In the DFB system, hot gas from the rotary apparatus 100 (100A, 100B) can provide both fluidization and heating for the circulating bed material, eliminating the need for external fuel supply and improving thermal efficiency of the system.

An amount of char and/or coke transferred into the combustor 104, 204 from the conversion reactor 102, 202 with the bed material depends on feedstock type and quality (for plastic waste for example, quality is defined with a percentage of polyolefins and an amount of impurities in the feedstock) and conversion process conditions. In conventional, fuel-fired DFB this char combusts in the combustor and provides energy needed for conversion reactions. In an event the inert gas (generated in the rotary apparatus 100, 100B) is used for heating, this char will not combust and will start to accumulate in the system. This char may be removed from the system in a manner shown on FIG. 1B (see 108). Purification unit 108 may also be used for mechanical separation and removal of heavy impurities, such as metals originating from plastic waste feedstock or carbon material which has formed a coke layer to surfaces, from the bed material matrix.

Removal of unreacted char from bed material circulating between the conversion reactor 102, 202 and the combustor/regenerator 104, 204 by means of mechanical separation would further allow for capturing carbon for further storage as a permanent carbon reservoir instead of releasing the same into the atmosphere in the form of carbon dioxide. Mechanical separation 108 may be implemented by the methods of density separation (e.g. cyclones), size separation (e.g. sieving), or by electrostatic separation (electrostatic precipitation). Additionally or alternatively, coke can be removed from the surface of bed material by milling. Other separation methods such as for example leaching can be used for separating char or coke from bed material.

Regular purification and replacement of bed material matrix will ensure flawless operation of the DFB unit comprising the rotary apparatus (-es) 100.

In embodiments, the facility 2000B comprising the DFB conversion unit 202, 204 is configured for processing of feedstocks under so called flash pyrolysis conditions, where a hot fluidized bed of material (e.g. sand) is rapidly contacted with feedstock 1 (e.g. plastic waste, oil shale or biomass) in non-oxidative conditions. Absence of oxygen or oxygen containing molecules like water or CO₂, ensures that the feedstock is not gasified or oxidized into oxygenated hydrocarbons like organic acids, aldehydes or alcohols. By means of flash pyrolysis, plastic feedstocks, such as plastics waste, may be converted into short-chain hydrocarbons (olefins) that can be further refined into new feedstock for plastic manufacturing, e.g. replacing naphtha.

In embodiments, the facility 2000B comprising the DFB conversion unit 202, 204 is configured to operate at steam cracking conditions. Compared to the DFB gasification described in relation to FIG. 1B, pyrolysis reactions implemented in dual fluidized bed systems generally proceed at lower temperatures (about 400-800° C. for non-oxidative pyrolysis and about 800-1000° C. for oxidative pyrolysis/steam cracking).

Steam cracking in the DFB conversion unit may be employed in converting of plastic feedstocks, such as plastic waste. In steam cracking conditions, polymer molecules break down to short-chain olefinic material. One-step plastic waste conversion to olefins, implemented in the DFB system allows for minimizing material losses, as well as energy consumption of the process.

The fluidized bed solutions described hereinabove may be implemented to carry out thermal processes (without catalyst) or thermal catalytic processes. Hence, in embodiments, any one of reactor devices 102, 104, 202, 204 described herein above and implemented as a fluidized bed device comprises catalyst. Exemplary catalysts include, but are not limited to catalytic pyrolysis of fluidized catalytic cracking for plastic feedstocks, for organic feedstocks or the combination thereof. Overall, any suitable catalyst may be utilized.

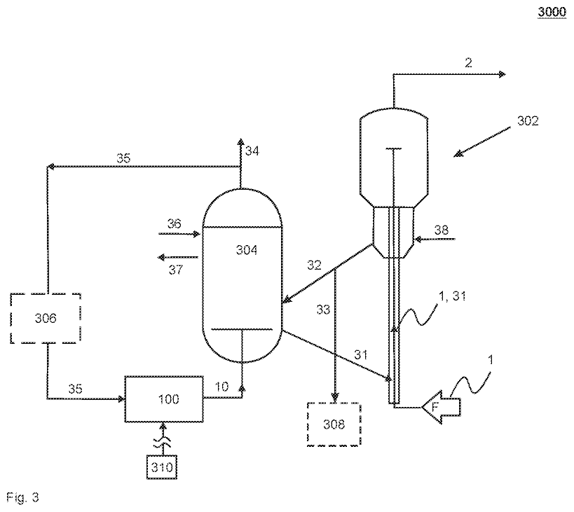

FIG. 3 schematically illustrates a feedstock conversion facility 3000 configured for catalytic cracking of carbon-based (carbonaceous) feedstocks. In embodiments, the facility 3000 is a Fluidized Catalytic Cracking (FCC) facility.

Facility 3000 comprises a feedstock conversion unit comprising a conversion reactor 302 and a regenerator 304, and at least one rotary apparatus 100. In the layout of FIG. 3 the conversion reactor is a FCC reactor adapted for catalytic cracking of carbonaceous feedstocks. Regenerator 304 is in turn configured as a catalyst regenerator device. FCC facility is particularly beneficial for conversion of plastic feedstocks, such as plastic waste, into aromatic hydrocarbons. Thus obtained light olefins and BTX aromatics (benzene, toluene and xylenes) can be further used to produce new plastics.

In the FCC process, hot (regenerated) catalyst stream 31 is combined with pre-heated feedstock 1 (typically in liquid form) at the bottom of the reactor riser (see arrow 1, 31), and the feed cracks as the mixture travels up the riser in a fluidized state into the reactor vessel, where cracked product gas is separated from spent catalyst. FCC reactor configured for cracking plastic feedstocks may operate at a temperature range within about 400-600° C. Cracked product gas 2 is sent for fractionation and recovery of usable products (not shown). Spent catalyst is separated from the product mixture by steam stripping (steam 38 being supplied into a stripper portion of the reactor 302), and transferred, at stream 32, to the regenerator 304. In the regenerator, coke deposited on the catalyst material during the cracking process is combusted by injecting air and heat, and regenerated catalyst is returned, at stream 31, back to the reactor 302 to continue the process loop. The processes of conversion (cracking) and catalyst regeneration run essentially continuously. Make-up catalyst 36 is supplied into the regenerator 304 as related amounts of contaminated catalyst 37 is withdrawn.

The rotary apparatus 100 integrated into the FCC layout 3000 may be configured to generate a stream of hot (650-750° C.) fluidic medium 10, preferably air, needed for combustion of coke in the regenerator 304. Supply of fresh medium may be accomplished from a suitable source 310.

Conventional FCC is an endothermic process. Heat required for cracking is typically produced by burning a small portion of feedstock in the regenerator 304. This leads to major fossil CO₂ emissions, which increase environmental footprint of the technology and cut sustainability benefits obtained from recycling of plastic waste. Therefore, removal of coke/char from the fluidized catalyst bed (stream 32) before it enters the regenerator 304 would be beneficial. Hence, at least a part of catalyst material may be directed, at stream 33, to a separation unit 308 for removal of coke/char. Separation unit 308 may be configured to carry out mechanical separation, as described earlier in the present specification (see description to FIG. 1B). Thermal efficiency of the system can be further improved by recycling, at stream 35, hot flue gas from the regenerator 304 into the rotary apparatus 100, optionally through a purification unit 306 (e.g. a hot filtration unit). In some configurations, flue gas may be purged, at stream 34, out of the regenerator 304. Providing at least a part of cracking energy by the rotary apparatus instead of balancing the operation by incinerating coke/char product may improve operational flexibility of the cracker unit.

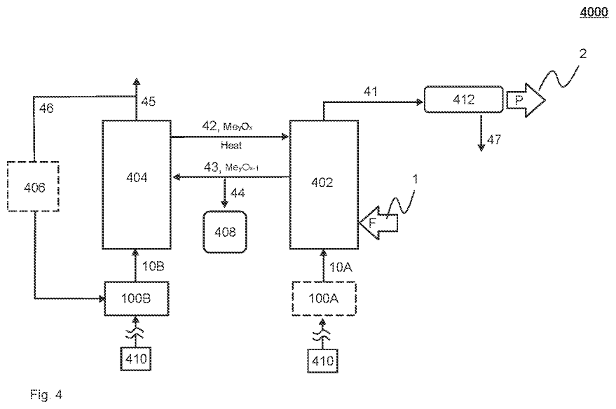

FIG. 4 illustrates, at 4000, a facility for converting solid carbon-based feedstocks into usable products via a process of chemical loop gasification. Facility 4000 generally follows operating principles outlined with regard to FIG. 1B; however, one of the features characteristic to chemical looping is that conversion of carbon-based feedstocks in a feedstock conversion unit is accompanied with oxidation-reduction (redox) reactions of a fluidized bed material, wherein the latter is provided as an oxygen carrier. Oxygen carrier is typically provided as metal oxide, and it is used to transfer oxygen from combustion air to solid feedstock (referred to as “fuel”), while avoiding direct contact between air and feed.

Feedstock conversion unit configured for chemical looping has a feedstock conversion section and a heat transfer (regeneration) section, wherein the feedstock conversion section is represented with a conversion reactor 402 embodied as a gasification reactor, and the heat transfer section is represented with a regenerator device 404. Regenerator device 404 is realized as a combustion reactor. Bed material made of solid oxygen carrier (metal oxide) is circulated between the reactors 402, 404, and the circulation process is accompanied with heat transfer and with redox reactions of metal oxide(s). In the process, oxygen carrier is subjected to continuous oxidation and reduction while they circulate throughout the conversion unit.

In regenerator 404, metal oxide Me_{y}Oₓ₋₁ arriving from the conversion reactor 402 (stream 43) is oxidized with combustion air to a higher oxidation state (Me_{y}Oₓ). Exemplary oxidation of iron (II, III) oxide proceeds according to the following scheme (Equation 12):

$$F {e}_{3} {O}_{4} ( s ) + {O}_{2} ( g ) \to F {e}_{2} {O}_{3} ( s ) \qquad ( 12 )$$

Fluidized bed material, now in oxidized state, flows, at stream 42, to the conversion reactor 402. Stream 42 also carries heat imparted to the bed material in the regenerator (combustor) 404. Conversion of solid feedstocks occurs in conversion reactor 402 when solid feedstock 1, introduced into the reactor, is mixed with fluidized oxygen carrier particles. In embodiments, the solid feedstock 1 is organic feedstock, such as biomass. Gaseous products exit the reactor 402 at stream 41 and proceed to fractionation. In the conversion process, oxygen carrier material is reduced back to a state Me_{y}Oₓ₋₁ and is sent back to regenerator at stream 43. In chemical looping, the metal oxide also acts as a heat transfer material, similar to what has been described with regard to FIG. 1B. In some configurations, at least a part of (reduced) bed material 43 may be directed, at stream 44, for char removal 408, which may be performed by steam stripping, for example.

Gaseous products 41, e.g. hydrogen (H₂), carbon oxides (CO, CO₂), methane (CH₄) and water vapour, formed in gasification proceed to fractionation/refining 412 to produce usable products 2, such as synthesis gas. Fractionation/refinement utilities 412 may include a Water-Gas Shift (WGS) reactor, a carbon dioxide separation unit, a Pressure Swing Adsorption (PSA) unit, and/or any other appropriate equipment. Off-gases 47 may be withdrawn or recycled (not shown).

Integration of the rotary apparatus (-es) into chemical looping facility 4000 is accomplished as follows. The rotary apparatus (-es) 100A, 100B may be configured to supply heated fluidic medium 10A, 10B to the conversion reactor 402 and the regenerator 404, respectively. Provision of the rotary apparatus 100B, for example, replaces fossil fuel-fired burner(s) typically used for heating combustion air. Hence, a stream 10B of (hot) combustion air injected into regenerator 404 may be generated by the rotary apparatus 100B. Flue gas exiting the regenerator 404 may be purged (stream 45) or, preferably, recycled, at stream 46, back to the rotary apparatus 100 (100B), optionally through a purification unit 406, the latter may be configured as a hot filtration unit. Recycling flue in the above described manner improves thermal efficiency of the system.

On the other hand, the rotary apparatus 100A may be configured to generate heated fluidic medium 10A suitable for use as a gasification agent. Fluids heated in the apparatus 100A may include carbon dioxide and/or water (to generate steam).

Fluids are supplied into the rotary apparatuses 100A, 100B from related source(s) 410.

It is noted that in all layouts 1000, 2000, 3000, 4000 described herein above and involving the use of fluidized bed reactor technology, the rotary apparatus 100 (100A, 100B) can be designed to increase pressure of the fluidic stream. Hence the rotary apparatus can be rendered with an additional blower function—to add velocity to heated fluidic medium supplied into the feedstock conversion unit(s). In this way, heated fluidic medium also serves as a fluidization agent and efficiently fluidizes the bed material in related reactor devices. The apparatus 100 adapted to act as blower provides necessary pressure increase for the fluid to circulate through the solid bed material provided within the feedstock conversion unit. The apparatus 100 may thus replace a separate air blower/system fan, otherwise necessary in conventional fuel-fired gasifiers (see FIG. 2A and an optional fan arrangement 212).

In embodiments, the method comprises generation of a heated fluidic medium by virtue of a rotary heater unit comprising or consisting of at least one rotary apparatus 100. The rotary heater apparatus 100 is preferably integrated into the feedstock conversion facility 1000, 2000, 3000, 4000. In an embodiment, the heated fluidic medium is produced by the at least one rotary apparatus; however, a plurality of rotary apparatuses may be used in series (in sequence) or in parallel.

The rotary apparatus 100 can be provided as a standalone apparatus or as a number of apparatuses arranged in series or in parallel. One or more apparatuses may be connected to a common feedstock conversion unit comprising at least one feedstock conversion device (conversion reactor) 102, 202, 302, 402. Where the conversion unit is configured as a combined reactor system (employing a conversion reactor and a regenerator/combustor 104, 204, 304, 404), at least one apparatus 100 may be connected to any one of the conversion reactor and the regenerator/combustor or both, within said combined reactor system.

In some configurations, a number of rotary apparatuses can be connected to several process utilities 102, 104, 202, 204, 302, 304, 402, 404. Different configurations may be conceived, such as n+x rotary apparatuses connected to n utilities (e.g. reactors), wherein n is equal to or more than zero (0) and x is equal to or more than one (1). Thus, in some configurations, the facility 1000, 2000, 3000, 4000 and, in particular, the rotary heater unit 100, may comprise one, two, three or four parallel rotary apparatus units connected to a common feedstock conversion unit, for example; the number of rotary apparatuses exceeding four (4) is not excluded. When connecting, in parallel, a number of rotary apparatuses to the common conversion unit, one or more of said apparatuses 100 may have different type of drive engine, e.g. the electric motor driven reactor(s) can be combined with those driven by steam turbine, gas turbine and/or gas engine.

The rotary apparatus 100 is configured to receive a feed stream supplied from an appropriate source 110, 210, 310, 410. Feed stream supplied into the apparatus 100 can comprise or consist of any fluid, such as liquid or gas or a combination thereof, provided as a pure component or a mixture of components.

In embodiments, fluidic medium entering the rotary apparatus 100 and/or heated therein comprises steam (H₂O). In embodiments, fluidic medium entering the rotary apparatus and/or heated therein comprises steam an oxidative gas, such as air or oxygen gas (O2). In embodiments, fluidic medium entering the apparatus 100 and/or heated therein comprises an oxidative gas, such as air or oxygen gas (O₂), or a combination thereof. In embodiments, fluidic medium entering the apparatus 100 and/or heated therein comprises a non-oxidative gas, such as nitrogen gas (N₂), hydrogen gas (H₂), a hydrocarbon-containing gas, such as for example methane (CH₄), or a combination thereof. In embodiments, fluidic medium entering the apparatus 100 and/or heated therein comprises a recycle gas recycled from exhaust gases generated during feedstock conversion process(es) in the feedstock conversion facility.

It is preferred that the apparatus 100 is supplied with a gaseous feed. Hence, units 110, 210, 310, 410 may be equipped gas preheating means and/or means for conversion of liquids into a gaseous form (not shown).

Flue gases generated in the conversion facility may be recycled into the apparatus 100, optionally trough a purification unit 106, 306, 406, as described herein above. By way of example, purification unit 106, 306, 406 can be adapted to purify exhaust gas (-es)/flue gas (-es) discharged from the feedstock conversion unit (primarily from combustion reactor(s) 104, 204, 304, 404), e.g. carbon dioxide, for further carbon capture (not shown). Suitable methods for purification of exhaust gases include for example filtration, such as hot filtration, distillation, absorption, Pressure Swing Adsorption (PSA), and any combination of these methods.

In embodiments, the disclosed method comprises generation of a heated fluidic medium by at least one rotary apparatus integrated into a related feedstock conversion facility, the at least one rotary apparatus comprising: (a) a rotor with a plurality of rotor blades arranged into at least one row around a rotor hub mounted onto a rotor shaft; (b) a plurality of stationary blades or vanes arranged into an assembly adjacent to the at least one row of rotor blades; and (c) a casing with a duct formed between at least one inlet and at least one outlet, the duct configured to encompass rotating and stationary blades such that bladeless portion(s) of the duct is/are arranged essentially subsequently to bladed portions thereof, wherein the rotary apparatus is configured to impart an amount of thermal energy to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated.

In addition to providing thermal energy required to carry out thermal or thermochemical conversion reaction and/or acting as a fluidization agent (as described above), the at least one rotary apparatus 100 integrated into the feedstock conversion facility 1000, 2000, 3000, 4000 may further replace, fully or partly, fuel-fired burners in the feedstock conversion unit and/or conversion facility.

In the facility 1000, 2000, 3000, 4000, the rotary apparatus (-es) 100 can be retrofitted with existing equipment, such as reactors and reactor systems, as described herein above.

Implementation of the rotary apparatus 100 may generally follow the disclosures of a rotary reactor apparatus according to the U.S. Pat. No. 7,232,937 (Bushuev), U.S. Pat. No. 9,494,038 (Bushuev) and U.S. Pat. No. 9,234,140 (Seppälä et al), and of a radial reactor apparatus according to the U.S. Pat. No. 10,744,480 (Xu & Rosic), the entire contents of which are incorporated by reference herewith. Any other implementation, which can be configured to adopt the method according to the embodiments, can be utilized.

In the patent documents referenced above, the rotary turbomachine-type apparatuses were designed as reactors for processing hydrocarbons, in particular, for steam cracking. General requirements for these applications are: rapid heating of gases, high temperature, short residence time, and plug flow (a flow model which implies no axial mixing). These requirements have led to designs where the turbomachine type reactors have several heating stages accommodated in a relatively small volume.

The present disclosure is based on an observation that the rotary apparatus (including, but not limited to the ones referenced above) can be used as a heater to generate the heated fluidic medium further supplied into thermal or thermochemical conversion processes related to recycling carbonaceous (waste) materials, such as plastics or organics, e.g. biomass, and producing valuable products. In some configurations, the apparatus 100 can be electrified. Hence, by integration of the rotary apparatus heater unit(s) into feedstock conversion process or processes, significant reductions in greenhouse gas—and particle emissions can be achieved.

The rotary apparatus 100 integrated into the feedstock conversion facility according to the embodiments and configured to generate the heated fluidic medium for the method(s) according to the embodiments thus comprises a rotor shaft positioned along a horizontal (longitudinal) axis with at least one rotor unit mounted onto the rotor shaft. The rotor unit comprises a plurality of rotor blades (also referred to as rotating or working blades) arranged over the circumference of a rotor hub or a rotor disk and together forming a rotor blade cascade. The rotary apparatus 100 thus comprises a plurality of rotor blades arranged into at least one row around the rotor hub or a rotor disk mounted onto the rotor shaft, and forming an essentially annular rotor blade assembly or rotor blade cascade.

In embodiments, the apparatus 100 further comprises a plurality of stationary blades or vanes arranged into an assembly adjacent to the at least one row of rotor blades. With the term “stationary” we refer to non-rotating blades/vanes (as contrary to the rotor blades). It is noted that attachment of stationary vanes to the casing (internal wall or lining thereof) may be fixed (non-movable) or essentially movable. In a latter case attachment of stationary vane (-s) may employ some degree of movement, allowing adjustment of the blade angle, to some extent, with regard to the rotor blades and/or the interior of the casing. Stationary blades/vanes may be attached directly to the casing (internal wall and/or lining thereof) or via auxiliary connector means such as for example rails, ring-shaped support frame, etc. Movable connection may be realized by hinged joints, or any other appropriate connection means.

In embodiments, said rotating and stationary blades are encompassed within an apparatus casing, in where a duct is formed, thus forming bladed portions of the duct. In embodiments, said rotating and stationary blades are arranged in the duct such that bladeless portions are formed, in the duct, essentially subsequently to stationary blades and/or rotating vanes. In embodiments, said bladeless portion(s) of the duct is/are arranged essentially subsequently to bladed portions thereof.

The rotary apparatus is thus configured to impart an amount of thermal energy to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated.

In some embodiments, the plurality of stationary vanes can be arranged into at least one stationary vane cascade, provided as an essentially annular assembly upstream and/or downstream of the at least one row of rotor blades.

A plurality of stationary vanes arranged into the assembly disposed upstream of the at least one row of rotor blades may be provided as stationary guide vanes (GV), such as inlet guiding vanes (IGV), and be configured, in terms of profiles, dimensions and disposition thereof around the central shaft, to direct the fluid flow into the rotor in a predetermined direction such, as to control and, in some instances, to maximize the rotor-specific work input capability.

In embodiments, the rotary apparatus 100 further comprises a diffuser area arranged downstream of the at least one row of rotor blades (rotor blade cascade). The diffuser area can be configured with or without stationary (diffuser) vanes. Hence, the diffuser area may be provided as an essentially bladeless portion of the duct or as a bladed portion of the duct. In a latter case the diffuser area comprises a vaned diffuser implemented as a plurality of stationary blades or vanes arranged into a diffuser vane cascade, provided as an essentially annular assembly downstream of the rotor. In some configurations, the diffuser area may encompass a vaneless diffuser.

The rotary apparatus can be configured with two or more essentially annular rows of rotor blades (blade cascades) sequentially arranged on/along the rotor shaft. In such an event, the stationary guide vanes may be installed upstream of the first row of the rotor blades, upstream of each row of rotor blades in the sequence, or upstream of any selected row of rotor blades in a sequential arrangement of the latter; and the stationary diffuser vanes may be installed downstream of the first row of the rotor blades, downstream of each row of rotor blades in the sequence, or downstream of any selected row of rotor blades in a sequential arrangement of the latter.

The rotor and the stationary blades (IGV and/or diffuser blades) are enclosed within an internal passageway (the duct) formed in the casing.

The diffuser area provided as an essentially bladeless portion of the duct is described in more detail in U.S. Pat. No. 10,744,480 to Xu and Rosic. In such configuration, provision of the diffuser device (whether vaned or vaneless) may be omitted, and diffuser area may be represented with the essentially bladeless portion of the duct (a so-called vaneless space) located downstream of the rotor and configured, in terms of its geometry and/or dimensional parameters, to diffuse a high-speed fluid flow arriving from the rotor.

Overall, provision of the bladeless/vaneless portion of the duct is common for all configurations of the rotary apparatus 100 described above. Depending on configuration, said bladeless portion is arranged subsequently (downstream) to the rotor blades (rf. U.S. Pat. No. 10,744,480 to Xu and Rosic) or subsequently (downstream) to stationary diffuser blades (rf. U.S. Pat. No. 9,494,038 to Bushuev and U.S. Pat. No. 9,234,140 to Seppälä et al). In some configuration described for example by Seppälä et al, arrangement of rotating and stationary blade rows in the internal passageway within the casing is such that bladeless portion(s) is/are created between an exit from the stationary diffuser blades disposed downstream of the rotor blades and an entrance to the stationary guide blades disposed upstream of the rotor blades of a subsequent rotor blade cascade unit.

The terms “upstream” and “downstream” refer hereby to spatial and/or functional arrangement of structural parts or components with relation to a predetermined part—or component, hereby, the rotor, in a direction of fluidic flow stream throughout the apparatus (from inlet to exit).

In some configurations, the at least one row of rotor (working) blades can be positioned between the rows of stationary (stator) vanes arranged into essentially annular assemblies (referred to as cascades) at one or both sides of the working blade row. Configurations including two or more rows of rotor blades/rotor blade cascades arranged in series (in sequence) on/along the rotor shaft may be conceived with or without stationary blades in between. In an absence of stationary vanes between the rotor blade rows, the speed of fluidic medium propagating through the duct increases in each subsequent row. In such an event, a plurality of stationary vanes may be arranged into assemblies upstream of a first rotor blade cascade in said sequence (as stationary guide vanes) and downstream of a lastmost rotor blade cascade (as stationary diffuser vanes).

The row of rotor blades (rotor blade cascade) and a portion of the duct downstream said rotor blades enclosed inside the casing optionally provided with an assembly of stationary diffuser vanes (diffuser area) may be viewed as a minimal process stage (hereafter, the stage), configured to mediate a complete energy conversion cycle. Hence, an amount of kinetic energy added to the stream of fluidic medium by at least one row of rotating blades is sufficient to raise the temperature of the fluidic medium to a predetermined value when said stream of fluidic medium exits the rotor blades and propagates, in the duct, towards a subsequent row of rotor blades, or enters the same row of rotor blades following an essentially helical trajectory formed within the essentially toroidal-shaped casing. Hence, thermal energy is added to the stream of fluidic medium flowing in the duct between the at least one inlet and the at least one outlet by virtue of converting mechanical energy of rotating blades of the rotor into internal energy of the fluid (whereby thermal energy is added to the fluidic stream) when said fluidic stream successively passes through bladed and bladeless portions of the duct. The duct (which encloses the periphery of the rotor) is preferably shaped such, that upon propagation of the fluidic stream in the duct, the stream decelerates and dissipates kinetic energy into an internal energy of the fluidic medium, and an amount of thermal energy is added to the stream of fluidic medium.

The stationary guide blade row(s) disposed upstream of the at least one row of rotor blades prepare required flow conditions at the entrance of the rotating blade row (cascade) during the energy conversion cycle.

In some configurations, the process stage is established with the assembly of stationary guide vanes (upstream of the rotor blades), the row of rotor blades and the diffuser area arranged downstream of said rotor blades, the diffuser area provided as the essentially vaneless portion of the duct optionally supplied with diffuser vanes. During the energy conversion cycle, enabled with successive propagation of the stream of fluidic medium through the stationary guide vanes, the at least one row of rotor blades and the diffuser area, respectively, in a controlled manner, mechanical energy of the rotor shaft is converted into kinetic energy and further-into internal energy of the fluid, followed by the rise of fluid temperature. An amount of kinetic energy added to the stream of fluidic medium by rotating blades of the rotor is sufficient to raise the temperature of the fluidic medium to a predetermined value when said stream of fluidic medium exits the rotor blades and passes, inside n the duct, through the diffuser area, whereupon the stream decelerates and dissipates kinetic energy into an internal energy of the fluidic medium, and an amount of thermal energy is added to the stream of fluidic medium. In the rotor blade row, the flow accelerates, and mechanical energy of the shaft and rotating blades is transferred to fluidic stream. In at least part of each rotor blade row the flow may reach a supersonic flow condition. In the diffuser area, the high-speed fluid flow arriving from the rotor is diffused with the significant entropy increase, whereby the flow dissipates kinetic energy into the internal energy of the fluidic substance, thus providing thermal energy into the fluid. If the flow upstream of the diffuser is supersonic, the kinetic energy of the fluidic stream is converted into internal energy of the fluid through a system of multiple shocks and viscous mixing and dissipation. An increase in the internal energy of the fluid results in a rise of fluid temperature. The energy conversion function may be performed by the vaneless portion of the duct located downstream of the rotor blades (rf. U.S. Pat. No. 10,744,480 to Xu & Rosic) and/or by an assembly of diffusing vanes, for example (rf. U.S. Pat. No. 9,234,140 to Seppälä et al).

The rotary apparatus 100 can be configured as a multistage- or a single-stage solution. Multistage configurations can be conceived comprising a number of rotor units (e.g. 1-5 rows of rotor blades sequentially arranged on/along the rotor shaft) alternating with bladeless area(s). In some configurations, the bladeless area(s) may be referred to as (bladeless) diffuser areas. In some configurations, the bladeless area(s) (bladeless portions of the ducts) may be arranged subsequently to stationary blades, such as stationary diffuser blades.

In an exemplary configuration outlined in U.S. Pat. No. 9,234,140 to Seppälä et al, the rotary apparatus 100 can be implemented substantially in a shape of a ring torus, where a cross-section of the duct in the meridian plane forms a ring-shaped profile. The apparatus comprises a rotor unit disposed between stationary guide vanes (nozzle vanes), and stationary diffusing vanes. The stages are formed with rows of stationary nozzle vanes, rotor blades and diffusing vanes, through which the fluidic stream propagates, in a successive manner, following a flow path established in accordance with an essentially helical trajectory. In this configuration, fluidic stream circulates through the rotating rotor blade cascade a number of times while propagating inside the apparatus between the inlet and the exit. Similar ring-shaped configuration is described in U.S. Pat. No. 9,494,038 to Bushuev.

In another exemplary configuration outlined in U.S. Pat. No. 9,234,140 to Seppälä et al, the rotary apparatus 100 can be configured as an essentially tubular, axial-type turbomachine. In such configuration, the apparatus comprises an extended (elongated) rotor hub, along which a plurality of rotor blades is arranged into a number of sequential rows. The rotor is enclosed within the casing, inner surface of which is provided with the stationary (stator) vanes and diffuser vanes, arranged such that blades/vanes of the stator, rotor—and diffuser cascades alternate along the rotor hub in a longitudinal direction (along the length of the rotor shaft, for inlet to exit). Blades of the rotor cascade at certain position along the rotor in the longitudinal direction form the stage with the adjacent pairs of stationary guide (nozzle) vanes and diffusing vanes, respectively.

In described configurations, the subsequent stages have blade/vane-free space between them.

In still another exemplary configuration outlined in U.S. Pat. No. 10,744,480 to Xu and Rosic, the rotary apparatus 100 can be configured as a radial turbomachine that generally follows a design for centrifugal compressors or centrifugal pumps. The term “centrifugal” implies that fluid flow within the device is radial; therefore, the apparatus may be referred, in the present disclosure, as a “radial-flow apparatus. The apparatus comprises a number of rotor units mounted onto elongated shaft, wherein each rotor unit is preceded with stationary guide vanes. A vaneless portion of the duct shaped in a manner enabling energy conversion (U-bend or S-bend, for example) is located after the rotor unit(s). Additionally, configuration may comprise a separate diffuser device (vaned or vaneless) disposed downstream of the rotor.

In all configurations described above, the rotary apparatus 100 performs, in the method disclosed herein, in similar manner. In operation, input energy conducted into the at least one rotary apparatus integrated into the feedstock conversion facility is converted into mechanical energy of the rotor. Conditions in the rotary apparatus are adjusted such, as to produce flow rate conditions, at which an amount of kinetic energy added to the stream of fluidic medium by rotating blades of the rotor is sufficient to raise the temperature of the fluidic medium to a predetermined value when said stream of fluidic medium exits the at least one row rotor blades and passes through the duct and/or through the diffuser area to enter the subsequent row of rotor blades or the same row of rotor blades in accordance to the description above. The row(s) of rotor blades may be preceded with stationary guide vanes. Hence, adjustable conditions comprise adjusting at least a flow of fluidic medium propagating inside the casing of the rotary apparatus, between the inlet and the exit. Adjusting the flow may include adjusting such apparatus operation related parameters, as temperature, mass flow rate, pressure, etc. Additionally or alternatively, flow conditions can be adjusted by modifying shape of the duct formed inside the casing.

In some exemplary configurations, the rotary apparatus can be configured to implement a fluidic flow between its inlet(s) and outlet(s) along a flow path established in accordance with any one of: an essentially helical trajectory formed within an essentially toroidal-shaped casing, as discussed in any one of the patent documents U.S. Pat. No. 9,494,038 to Bushuev and U.S. Pat. No. 9,234,140 to Seppälä et al; an essentially helical trajectory formed within an essentially tubular casing, as discussed in the patent document U.S. Pat. No. 9,234,140 to Seppälä et al; an essentially radial trajectory as discussed in the patent document U.S. Pat. No. 10,744,480 to Xu & Rosic; and along the flow path established by virtue of the stream of fluidic medium in the form of two spirals rolled up into vortex rings of right and left directions, as discussed in the patent document U.S. Pat. No. 7,232,937 to Bushuev). The aerodynamic design of the rotary apparatus can vary.

The rotary apparatus 100 utilizes a drive engine. In some configurations, the apparatus utilizes electrical energy as input energy and is therefore electric motor-driven. For the purposes of the present disclosure, any appropriate type of electric motor (i.e. a device capable of transferring energy from an electrical source to a mechanical load) can be utilized. Suitable coupling(s) arranged between a motor drive shaft and the rotor shaft, as well as various appliances, such as power converters, controllers and the like, are not described herewith. Additionally, the apparatus can be directly driven by gas—or steam turbine, for example, or any other appropriate drive device. In layouts involving parallel connection of a number of rotary apparatuses 100 to a common feedstock conversion unit 102, 102+104, 202, 202+204, 302+304, 402+404, such as a furnace, for example, one or more of said apparatuses may utilize different type of drive engine, e.g. the electric motor driven apparatuses can be combined with those driven by steam turbine, gas turbine and/or gas engine.

An amount of input energy E_{I} may thus be conducted into the at least one rotary apparatus 100 integrated, as a (rotary) heater unit, into the conversion facility 1000, 2000, 3000, 4000. The input energy E_{I} may comprise electrical energy supplied from external or internal source (as related to the rotary apparatus itself and/or the conversion facility. Electrical input energy EI supplied into the apparatus can be defined in terms of electric power, the latter being defined as a rate of energy transfer per unit time (measured in Watt). Electric power can be supplied into the rotary apparatus through supplying electric current to the electric motor used to propel a rotary shaft of the apparatus.

Electric power can be supplied from an electricity generating system that exploits at least one source of renewable energy or a combination of the electricity generating systems exploiting different sources of renewable energy. External sources of renewable energy can be provided as solar, wind—and/or hydropower. Thus, electric power may be received into the process from at least one of the following units: a photovoltaic electricity generating system, a wind-powered electricity generating system, and a hydroelectric power system. In some exemplary instances, a nuclear power plant may be provided as the external source of electrical power. Nuclear power plants are generally regarded as emission-free. The term “nuclear power plant” should be interpreted as using traditional nuclear power and, additionally or alternatively, fusion power.

Electricity can be supplied from a power plant that utilizes a turbine as a kinetic energy source to drive electricity generators. In some instances, electric power to drive the at least one apparatus 100 can be supplied from at least one gas turbine (GT) provided as a separate installation or within a cogeneration facility and/or a combined cycle power facility, for example. Electric power can thus be supplied from at least one of the following units: a combined cycle power facility, such as a combined cycle gas turbine plant (CCGT), and/or a cogeneration facility configured for electricity production combined with heat recovery and utilization through combined heat and power (CHP), for example. In some examples, the CHP plant can be a biomass fired plant to increase the share of renewable energy in the process described. Additionally or alternatively, supply of electric power can be realized from a spark ignition engine, such as a gas engine, for example, and/or a compression engine, such as a diesel engine, for example, optionally provided as a part of an engine power plant. Still further, any conventional power plant configured to produce electrical energy from fossil raw materials, such as coal, oil, natural gas, gasoline, and the like, typically mediated with the use of steam turbines, can be used to generate electrical energy as an input energy for the rotary apparatus 100. Also hydrogen can be utilized as a source of renewable energy, to be reconverted into electricity, for example, using fuel cells.

Any combination of the abovementioned sources of electric power, realized as external and internal sources, may be conceived. Importing low emission electric power from an alternative (external) source improves energy efficiency of the feedstock conversion facility.

Conducting input energy, comprising electrical power, into a drive engine of the rotary apparatus can be further accompanied with conducting mechanical shaft power thereto from a power turbine, for example, optionally utilizing thermal energy generated elsewhere in the facility 1000 or outside said facility. Shaft power is defined as mechanical power transmitted from one rotating element to another and calculated as a sum of the torque and the speed of rotation of the shaft. Mechanical power is defined, in turn, as an amount of work or energy per unit time (measured in Watt).

In practice, the shaft power from the electric motor and the power turbine, for example, can be divided so that any one of those can provide the full shaft power or a fraction of it.

In embodiments, the disclosed method comprises generation of the heated fluidic medium by at least two rotary apparatuses integrated into the feedstock conversion facility, said at least two rotary apparatuses being connected in parallel or in series (not shown).

Upon connecting the at least two rotary apparatuses in parallel or in series, a rotary apparatus assembly can be established. Connection between rotary apparatuses in the assembly may be mechanical and/or functional. Functional (in terms of achievable heat input, for example) connection can be established upon association between at least two individual, physically integrated—or non-integrated individual apparatus units. In a latter case, association between the at least two rotary apparatuses can be established via a number of auxiliary installations (not shown). In some configurations, the assembly comprises the at least two apparatuses connected such, as to mirror each other, whereby said at least two apparatuses are at least functionally connected via their central (rotor) shafts. Such mirrored configuration can be further defined as having the at least two rotary apparatuses 100 mechanically connected in series (in a sequence), whereas functional connection can be viewed as connection in parallel (in arrays). In some instances, the aforesaid “mirrored” arrangement can be further modified to comprise at least two inlets and a common exhaust (discharge) module placed essentially in the center of the arrangement.

A number of rotary apparatuses can be assembled on the same (rotor) shaft (not shown). Each rotary apparatus can be optionally provided with a separate drive (a motor) which allows independent optimization of the apparatuses. When two or more separate rotary apparatuses are used, construction costs (materials etc.) can be optimized in view of operation temperature and pressure.

In an event two rotary apparatus are connected in sequence, a first apparatus in the sequence may serve as a primary heater and a second one—as a so-called booster heater (to further raise temperature of fluids heated in the primary apparatus optionally by injecting reactive chemicals thereto).

In an aspect, a feedstock conversion facility 1000, 2000, 3000, 4000 comprising at least one rotary apparatus 100 configured to generate a heated fluidic medium, and at least one feedstock conversion unit 102, 102+104, 202, 202+204, 302+304, 402+404, configured to carry out a process or processes related to thermal or thermochemical conversion of carbon-based feedstocks into usable products, is provided, the at least one rotary apparatus comprising: (a) a rotor with a plurality of rotor blades arranged into at least one row around a rotor hub mounted onto a rotor shaft; (b) a plurality of stationary blades or vanes arranged into an assembly adjacent to the at least one row of rotor blades; and (c) a casing with a duct formed between at least one inlet and at least one outlet, the duct configured to encompass rotating and stationary blades such that bladeless portion(s) of the duct is/are arranged essentially subsequently to bladed portions thereof, wherein the at least one rotary apparatus is configured to operate such that an amount of thermal energy is imparted to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated, and wherein said at least one rotary apparatus is configured to receive an amount of input energy, and to generate a heated fluidic medium for inputting thermal energy into at least one feedstock conversion unit configured to carry out feedstock conversion process(es) at temperatures essentially equal to or exceeding about 400 degrees Celsius (° C.).

In embodiments, the feedstock conversion facility is configured to implement thermal or thermochemical conversion of carbon-based feedstocks into usable products through a method according to some previously defined aspects and embodiments.

In embodiments, the feedstock conversion facility is configured as a plastic waste conversion facility and/or an organic waste conversion facility. In embodiments, the facility is configured to convert plastic and/or organic waste into value-added substances such as fuels including any one of solid fuels, liquid fuels (e.g. (bio)-oils) and gases (e.g. (bio)-gas, synthesis gas), (solid, liquids or gas), chemical compounds, and energy (heat and electricity).

It is clear to a person skilled in the art that with the advancement of technology the basic ideas of the present invention may be implemented and combined in various ways. The invention and its embodiments are thus not limited to the examples described herein above, instead they may generally vary within the scope of the appended claims.

1. A method for thermal or thermochemical conversion of carbon-based feedstocks into usable products, the method comprising generation of a heated fluidic medium by at least one rotary apparatus integrated into a related feedstock conversion facility, the at least one rotary apparatus comprising:
a rotor with a plurality of rotor blades arranged into at least one row around a rotor hub mounted onto a rotor shaft,
a plurality of stationary blades or vanes arranged into an assembly adjacent to the at least one row of rotor blades, and
a casing with a duct formed between at least one inlet and at least one outlet, the duct configured to encompass rotating and stationary blades such that bladeless portion(s) of the duct is/are arranged essentially subsequently to bladed portions thereof,
wherein the rotary apparatus is configured to impart thermal energy to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated, and
wherein the method further comprises:
supplying the stream of heated fluidic medium generated by the at least one rotary apparatus into the feedstock conversion facility, and
operating said at least one rotary apparatus and said feedstock conversion facility to carry out thermal or thermochemical conversion of carbon-based feedstocks into usable products at temperatures essentially equal to or exceeding about 400 degrees Celsius (° C.).

2. The method of claim 1, wherein, in the feedstock conversion facility, the at least one rotary apparatus is connected to at least one feedstock conversion unit configured to carry out thermal or thermochemical carbon-based feedstock conversion process or processes at temperatures essentially equal to or exceeding about 400 degrees Celsius (° C.).

3. The method of claim 1, comprising supplying the stream of heated fluidic medium generated by at least one rotary apparatus into the at least one feedstock conversion unit within the feedstock conversion facility.

4. The method of claim 1, comprising bringing the stream of heated fluidic medium generated by at least one rotary apparatus into contact with carbon-based feedstock in the at least one feedstock conversion unit, wherein said heated fluidic medium generated by at least one rotary apparatus provides heat for thermal or thermochemical conversion of said essentially solid carbon-based feedstocks into usable products.

5. The method of claim 1, comprising bringing the stream of heated fluidic medium generated by at least one rotary apparatus into contact with heat transfer material in a heat transfer section of the feedstock conversion unit, and transferring heated heat transfer material from the heat transfer section into a conversion section of the feedstock conversion unit, in which conversion section the heated heat transfer material provides heat for thermal or thermochemical conversion of carbon-based feedstocks into usable products.

6. The method of claim 5, further comprising transferring the heat transfer material from the conversion section of the feedstock conversion unit back to the heat transfer section for re-heating, wherein at least a part of said heat transfer material is transferred from the conversion section to the heat transfer section through a purification unit, in which the heat transfer material is purified from unreacted carbon char and coke.

7. The method of claim 5, wherein, in said feedstock conversion unit, the processes of heat transfer and conversion are conducted in an essentially closed-loop pathway.

8. The method of claim 1, wherein the feedstock conversion unit comprises at least one fluidized bed device.

9. The method of claim 8, wherein the at least one fluidized bed device comprises catalyst.

10. The method of claim 5, comprising fluidization of carbon-based feedstock with the heated fluidic medium generated in the at least one rotary apparatus.

11. The method of claim 8, wherein, in the at least one fluidized bed device, the carbon-based feedstock is mixed with essentially solid bed material.

12. The method of claim 11, wherein the essentially solid bed material comprises particulate or powder.

13. The method of claim 8, wherein, in the at least one fluidized bed device, the bed material consists of carbon-based feedstock provided as particulate or powder.

14. The method of claim 5, wherein the feedstock conversion unit is configured as a dual fluidized bed reactor.

15. The method of claim 1, wherein thermal or thermochemical conversion of carbon-based feedstock is carried out by gasification or by pyrolysis optionally implemented at steam cracking conditions.

16. The method of claim 15, wherein the feedstock conversion unit comprises or consists of a gasifier or a pyroliser optionally operated at steam cracking conditions.

17. The method of claim 6, wherein the heat transfer material is a metal oxide material, and wherein conversion of carbon-based feedstocks in the feedstock conversion unit is accompanied with oxidation-reduction (redox) reactions of said metal oxide material.

18. The method of claim 1, comprising supplying the stream of heated fluidic medium generated by the at least one rotary apparatus into the feedstock conversion facility to provide external heat to at least one feedstock conversion unit within said facility.

19. The method of claim 1, wherein the fluidic medium that enters the rotary apparatus is an essentially gaseous medium.

20. The method of claim 1, wherein the heated fluidic medium generated by the at least one rotary apparatus comprises steam (H₂O).

21. The method of claim 1, wherein the heated fluidic medium generated by the at least one rotary apparatus comprises an oxidative gas, such as air or oxygen gas (O₂), or a combination thereof.

22. The method of claim 1, wherein the heated fluidic medium generated by the at least one rotary apparatus comprises a non-oxidative gas, such as nitrogen gas (N₂), hydrogen gas (H₂), a hydrocarbon-containing gas, or a combination thereof.

23. The method of claim 1, wherein the heated fluidic medium generated by the rotary apparatus comprises a recycle gas recycled from exhaust gases generated during feedstock conversion process(es) in the feedstock conversion facility.

24. The method of claim 1, comprising generation, by at least one rotary apparatus of the fluidic medium heated to any one of (i) temperatures within a range of about 400° C. to about 800° C.; (ii) temperatures within a range of about 800° C. to about 1000° C.; and (iii) temperatures exceeding 1000° C., preferably, provided within a range of about 1000° C. to about 1700° C.

25. The method of claim 1, comprising adjusting velocity and/or pressure of the stream of fluidic medium propagating through the rotary apparatus.

26. The method of claim 1, wherein heated fluidic medium is generated by at least one rotary apparatus comprising two or more rows of rotor blades sequentially arranged along the rotor shaft.

27. The method of claim 1, wherein the heated fluidic medium is generated by at least one rotary apparatus, in which the bladeless portion of the duct is arranged downstream of the at least one row of rotor blades.

28. The method of claim 1, wherein the at least one rotary apparatus is electrically operated and wherein electrical energy constitutes 5 to 100 percent of a total energy consumption by said at least one rotary apparatus.

29. The method of claim 28, wherein electrical energy consumed by the at least one rotary apparatus is obtainable from a source of renewable energy or a combination of different sources of energy, optionally, renewable energy.

30. The method of claim 1, wherein the at least one rotary apparatus is additionally or alternatively configured to receive input energy from a non-electric power source, such as a power turbine and/or a mechanical drive engine.

31. The method of claim 1, comprising generation of the heated fluidic medium by at least two rotary apparatuses integrated into the feedstock conversion facility, wherein the at least two rotary apparatuses are connected in parallel or in series.

32. The method of claim 1, wherein the carbon-based feedstock comprises plastic material and/or organic material, optionally, plastic waste and/or organic waste.

33. The method of claim 1, comprising pre-treatment of the carbon-based feedstock, wherein pre-treatment comprises size-reduction of feedstock particles carried out through grinding, such as cryogenic grinding.

34. The A feedstock conversion facility comprising at least one rotary apparatus configured to generate a heated fluidic medium, and at least one feedstock conversion unit configured to carry out a process or processes related to thermal or thermochemical conversion of carbon-based feedstocks into usable products, the at least one rotary apparatus comprising:
a rotor with a plurality of rotor blades arranged into at least one row around a rotor hub mounted onto a rotor shaft,
a plurality of stationary blades or vanes arranged into an assembly adjacent to the at least one row of rotor blades, and
a casing with a duct formed between at least one inlet and at least one outlet, the duct configured to encompass rotating and stationary blades such that bladeless portion(s) of the duct is/are arranged essentially subsequently to bladed portions thereof,
wherein the at least one rotary apparatus is configured to operate such that thermal energy is imparted to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated, and
wherein said at least one rotary apparatus is configured to generate a heated fluidic medium for inputting thermal energy into at least one feedstock conversion unit configured to carry out feedstock conversion process(es) at temperatures essentially equal to or exceeding about 400 degrees Celsius (° C.).

35. A feedstock conversion facility comprising at least one rotary apparatus configured to generate a heated fluidic medium, and at least one feedstock conversion unit configured to carry out a process or processes related to thermal or thermochemical conversion of carbon-based feedstocks into usable products, the at least one rotary apparatus comprising:
a rotor with a plurality of rotor blades arranged into at least one row around a rotor hub mounted onto a rotor shaft,
a plurality of stationary blades or vanes arranged into an assembly adjacent to the at least one row of rotor blades, and
a casing with a duct formed between at least one inlet and at least one outlet, the duct configured to encompass rotating and stationary blades such that bladeless portion(s) of the duct is/are arranged essentially subsequently to bladed portions thereof,
wherein the at least one rotary apparatus is configured to operate such that thermal energy is imparted to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated, and
wherein said at least one rotary apparatus is configured to generate a heated fluidic medium for inputting thermal energy into at least one feedstock conversion unit configured to carry out feedstock conversion process(es) at temperatures essentially equal to or exceeding about 400 degrees Celsius (° C.),
wherein the feedstock conversion facility is configured to implement a method according to claim 1.

36. The feedstock conversion facility of claim 34, configured as a plastic material conversion and/or recycling facility, optionally as a plastic waste conversion and/or recycling facility, and/or as an organic material conversion facility.
